(19) United States
(12) Patent Application Publication
(10) Pub. No.: US 2021/0162664 A1
(43) Pub. Date: Jun. 3, 2021

(54) 3D PRINTER

(71) Applicant: RD HOLDINGS LTD, Fareham, Hampshire (GB)

(72) Inventor: Guy RAYNES, Fareham (GB)

(73) Assignee: RD HOLDINGS LTD, Fareham, Hampshire (GB)

(21) Appl. No.: 17/045,260

(22) PCT Filed: Apr. 5, 2019
(86) PCT No.: PCT/GB2019/051017

§ 371 Date: Oct. 5, 2020

(30) Foreign Application Priority Data
Apr. 5, 2018 (GB) 1805738.0

(51) Int. Cl. B29C 64/245; B29C 64/393; B29C 64/118; B29C 64/227; B29C 64/295; B29C 64/25; B29C 64/364; B29C 64/209; B33Y 30/00; B33Y 50/02

(52) U.S. Cl. CPC B29C 64/245; B29C 64/393; B29C 64/118; B29C 64/227; B33Y 50/02; B29C 64/25; B29C 64/364; B29C 64/209; B33Y 30/00; B29C 64/295

(57) ABSTRACT

A 3D printer is described, which comprises a housing providing a printing chamber, a liquid print head, movably mounted within the housing, for dispensing a liquid, a print bed at the base of the printing chamber for receiving an object to be fully or partially filled by the liquid print head, and one or more apertures for drawing air from the object using a vacuum pump. In this way, the filling of an object with printed liquid can be achieved more effectively than relying on gravity alone, and a reduction in the number of air bubbles can be achieved.

### TECHNICAL FIELD

The present invention relates to a 3D printer, and to a filament drive mechanism for a 3D printer.

### BACKGROUND

3D printers enable simple products to be manufactured simply and cheaply. However, existing 3D printers are unable to make complex finished products, because they print only a single family of materials and cannot decorate the 3D printed product. It would be desirable to be able to 3D print commercial products which are more than simply inanimate plastic or metal but are instead a combination of electronics (for example) and plastic.

The present invention has been devised to address some of the limitations of existing 3D printers, and seeks to provide a 3D printer which can print finished products or, or at least to print a product in kit form requiring minimal assembly.

### SUMMARY OF THE INVENTION

According to an aspect of the present invention, there is provided a 3D printer, comprising:
a housing providing a printing chamber; and
a liquid print head, movably mounted within the housing, for dispensing a liquid; and
a print bed at the base of the printing chamber for receiving an object to be fully or partially filled by the liquid print head; and
one or more apertures for drawing air from the object using a vacuum pump.

By drawing air from the object (either by disposing the aperture(s) within, at or proximate an opening into the object, or by disposing the aperture(s) elsewhere within the 3D printer and relying on a global vacuum within the printing chamber to draw air from the object), the filling of an object with printed liquid can be achieved more effectively than relying on gravity alone, and a reduction in the number of air bubbles in the printed liquid can be achieved.

The apertures may be disposed in or at one or both of the housing and the print head. If disposed in the housing, the apertures may be provided in the walls, ceiling, or at any other component within the 3D printer. If disposed at the print head (for example on a platform bearing the print head and optionally one or more other print heads and/or other tools), a flexible tube may extend from the aperture to a vacuum pump provided within or externally of the 3D printer. Either alternatively, or in addition, the apertures may be disposed in the print bed.

The printing chamber may be a sealed chamber, and the vacuum pump may be operable to draw air out of the printing chamber via the one or more apertures.

A further print head may be provided for printing the object onto the print bed prior to it being filled using the liquid print head. The further print head may be a fused deposition modelling (FDM) print head.

The liquid print head may be operable to dispense liquid into a first opening into the object while the one or more apertures draw air from the interior of the object via a second opening into the object. In this case, the further print head may be operable to complete the mould by printing over the first and/or second opening once a process of dispensing liquid into the mould has been completed.

The 3D printer may comprise a hopper containing the liquid, and the hopper may be pressurised by the pumping action of the vacuum pump.

The 3D printer may comprise the vacuum pump.

The further print head may be operable to pause printing, and the housing may be opened to permit the manual insertion of an external object into the mould. The manual insertion of the external object may occur prior to, or part-way through, liquid being dispensed into the mould.

The 3D printer may comprise a filament drive mechanism supplying filaments of printing material to the further print head, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

According to another aspect of the present invention, there is provided filament drive mechanism for a 3D printer, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

In this way, cam position can be used to control filament engagement, with the cams potentially being driven by a single actuator (stepper motor or servo for example), rather than requiring a separate actuator to control each filament. This leads to a reduction is weight, and a reduction in a number of parts (potentially improving reliability).

The plurality of drive surfaces may be arranged on a single drive shaft.

The plurality of cams may be arranged on a single cam shaft, and the rotational position of the cam shaft may control the rotational position of the cams. Alternatively, the cams may be on separate cam shafts, but coupled together via gears such that a single stepper motor or servo and be used to drive them.

The plurality of pressure surfaces may form part of respective cam following units, each cam following unit being movable within a channel under the action of the respective cam to engage and disengage the pressure surface from the filament. The plurality of pressure surfaces may be wheels mounted within the cam following units. Each cam following unit may comprise first and second parts, the first part being coupled to the cam and the second part bearing the pressure surface, the first and second parts being biased away from each other via biasing elements, wherein when the pressure surface is pressed against the filament the force applied from the cam to the pressure surface via the biasing elements overcomes the bias to move the first and second parts closer to each other. The biasing elements may each comprise a pair of opposed magnets, the action of the cams overcoming a magnetic repulsion between the pair of magnets.

In another embodiment, each cam following unit may comprise first and second parts, again with the first part being coupled to the cam and the second part bearing the pressure surface. The second part may be movably disposed within the first part. The first part may be biased towards the cam by a first biasing element, with the action of the cam overcoming the bias provided by the first biasing element to drive the first part (and with it the second part) towards the drive surface. The second part may be biased towards the drive surface (or away from the first part) by a second biasing element. When the first part is urged towards the filament and the drive surface by the cam, the second part moves with it because of the bias provided by the second biasing element. As a result, the pressure surface comes into contact with the filament, and the second biasing element prevents too much pressure being applied to the filament. Accordingly, and similarly to the previous embodiment, when the pressure surface is pressed against the filament the force applied from the cam to the pressure surface via the biasing elements overcomes the bias to move the first and second parts closer to each other. The first and/or second biasing elements may be springs. A single spring having two parts may be used, one part defining the first biasing element and the other part defining the second biasing element.

The filament drive mechanism may comprise at least 3 filaments, at least 3 drive surfaces, at least 3 pressure surfaces and at least 3 cams. It will be appreciated that a smaller number (zero or one) may be provided, or a larger number may be provided, depending on specific requirements.

The cam following unit may be coupled to its respective cam by a pin which engages with a groove on the cam, the groove defining a path on the cam which causes the pin, and therefore the cam following unit, to move towards or away from the filament as the cam is rotated and the pin follows the path of the groove. The groove may be similar in shape to, and proximate, a circumference of the cam. The cam following unit may comprise a cut-out portion or slot which the rotational axis of the cam extends through.

Alternatively, the cam following unit may have a cam follower which contacts its respective cam, and causes the cam following unit to be deflected as the cam rotates to move the cam following unit (and thus the pressure surface) closer to or further from the filament and the drive surface.

The drive surfaces may each comprise a drive wheel coupled to a motor. The drive wheel may be toothed.

The filament path may enter the filament drive mechanism at an inlet and exits the filament drive mechanism at an outlet, the filament path being surrounded by a first guide formation proximate the inlet and a second guide formation proximate the outlet and being exposed between the first and second guide formations in the vicinity of the respective drive surface. The first guide formation and the second guide formation may taper towards the position of the drive surface to permit the filament to be in contact with the drive surface over a short length.

The rotational position of the cams may be controlled by a servo or stepper motor.

The paths of the grooves on the cams and/or the rotational positions of the cams on the cam shaft relative to each other and/or the shape of the cams may be such that by varying the rotational position of the cam shaft a selected two or more of the pressure surfaces can be brought into contact with the respective filaments at the same time. The paths of the grooves on the cams and/or the rotational positions on the cams on the cam shaft relative to each other and/or the shape of the cams may be such that at one or more rotational positions of the cam shaft all of the pressure surfaces can be brought into contact with the respective filaments at the same time. A first of the two or more pressure surfaces in contact with the filaments may apply sufficient pressure to fully engage the filament with the drive surface while a second of the two or more pressure surfaces in contact with the filaments applies sufficient pressure to only partially engage the filament with the drive surface.

Any individual pressure surface or combination of pressure surfaces can be brought into contact with the respective filaments at the same time by setting an appropriate rotational position of the cam shaft. An amount of engagement of a filament with the respective drive surface may be controlled by setting an appropriate rotational position of the cam shaft.

According to another aspect of the present invention, there is provided a 3D printer, comprising:
a housing providing a printing chamber; and
a print head, movably mounted within the housing, for dispensing a printing material; and
a filament drive mechanism according to the above, the filament drive mechanism being operable to supply a selected filament to the print head.

According to another aspect of the present invention, there is provided a 3D printer, comprising:
a housing providing a printing chamber;
a print bed at the base of the printing chamber; and
a pump device;
wherein the print bed comprises a heating element, and one or more conduits disposed proximate the heating element, and wherein the pump is operable to drive or draw air through the conduits and into the printing chamber.

In this way, heated air can be introduced into the printing chamber by using heat from the heating element in the print bed. This results in the introduced air being ready-heated upon its introduction into the printing chamber, without requiring a separate external heating element to be provided.

The heating element may be substantially planar and extend across the print bed. The one or more conduits may extend from an inlet to an outlet at or near the periphery of the print bed. The inlet may be disposed beneath the heating element. The inlet may be disposed substantially centrally of the heating element, and a plurality of conduits may be provided which extend from the inlet to a plurality of outlets about the periphery of the print bed.

The plurality of conduits may extend radially from the inlet to their respective outlets. The one or more conduits may extend horizontally beneath the heating element.

The pump device may be operable in a vacuum mode to draw air from the printing chamber and through the one or more conduits to evacuate the printing chamber.

An exhaust may be provided through which the evacuated air is expelled to the atmosphere. A filter may be provided for filtering the evacuated air.

A temperature sensor may be provided for measuring a temperature within the printing chamber, and a controller for controlling the operation of the pump device in dependence on the measured temperature to achieve and/or maintain a desired temperature within the printing chamber.

The pump device may comprise a valve and a pumping motor, and the controller may be operable to control one or both of the valve and the motor to regulate an air flow rate through the one or more conduits. The pump device may comprise an air pump for driving air through the one or more conduits and into the printing chamber, and a vacuum pump for drawing air out of the printing chamber and through the one or more conduits, and a valve for selecting which one of the air pump and the vacuum pump is in fluid communication with the one or more conduits.

The pump device may be located beneath the printing bed.

A print head may be provided, movably mounted within the printing chamber, for dispensing a printing material onto the printing bed. The print head may be operable to print over and seal one or more of the apertures to control the flow of air into and/or out of the printing chamber.

The 3D printer may comprise a liquid print head, movably mounted within the housing, for dispensing a liquid; wherein the print bed is for receiving an object to be fully or partially filled by the liquid print head; and the 3D printer comprises one or more apertures for drawing air from the object using a vacuum pump.

The 3D printer may comprise a filament drive mechanism for supplying filaments of printing material to the print head, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

According to another aspect of the present invention, there is provided a 3D printer, comprising:
a housing providing a printing chamber;
a print head platform, movably mounted within the housing, having a print head for dispensing a printing material, the print head platform being movable vertically and horizontally; and
a filament elevator, movably mounted within the housing, for carrying one or more filaments of printing material for use by the print head, the filament elevator being movable vertically to stay within a first predetermined distance from the print head platform.

In this way, the separation between the print head platform and the filaments can be kept relatively uniform (within a range), reducing the distance the filament is required to travel to the print head, and reducing flexing and kinking of the filaments.

The filament elevator may be movable vertically to stay outside of a further predetermined distance from the print head platform.

The 3D printer may comprise a plurality of pillars, each pillar having first and second carriages arranged to move vertically on the pillar, the second carriage being disposed above the first carriage;
wherein the print head platform is movably mounted within the housing via the first carriages of the plurality of pillars, and is movable vertically and horizontally by moving the first carriages independently of each other;
wherein the filament elevator is movably mounted within the housing via the second carriages, the filament elevator being movable vertically by moving the second carriages together; and
wherein the second carriages are constrained to move together vertically on the pillars, and wherein the vertical position of the second carriages is dictated by the vertical position of the highest one or more of the first carriages

A drive mechanism may be provided for controlling the vertical position of each of the first carriages independently, wherein if the drive mechanism causes the highest one or more of the first carriages to move upwardly, the second carriages are carried upwardly with the highest one or more of the first carriages, and wherein if the drive mechanism causes the highest one or more of the first carriages to move downwardly, the second carriages are permitted to move downwardly.

The filament elevator may carry a filament drive mechanism for extruding the filaments towards the printing head. The extruded filament may be conveyed to the printing head via a tube.

The first carriages may be coupled to the printing head platform by connecting rods, each connecting rod being pivotally mounted both to the printing head platform and to its first carriage, and wherein the second carriages are coupled to the filament elevator by fixed connecting rods.

The filament elevator may be connected to an upper part of the housing by a support mechanism, the support mechanism bearing a substantial portion of the weight of the filament elevator, the remainder of the weight of the filament elevator being sufficient to drive the second carriages downwardly to follow the highest one or more of the first carriages when the highest one or more of the first carriages is caused to descend. The support mechanism may comprise one of a pulley or an elasticated support.

The print head platform may have a liquid print head, for dispensing a liquid; wherein a print bed is disposed at or near the base of the printing chamber for receiving an object to be fully or partially filled by the liquid print head; and the 3D printer comprises one or more apertures for drawing air from the object using a vacuum pump.

The drive mechanism may comprise:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

A print bed may be provided at the base of the printing chamber, and a pump device; wherein the print bed comprises a heating element, and one or more conduits disposed proximate the heating element, and wherein the pump is operable to drive or draw air through the conduits and into the printing chamber.

According to another aspect of the present invention, there is provided a 3D printer, comprising:
a housing providing a printing chamber; and
a print head, movably mounted within the housing, for dispensing a printing material; and
a utility head, movably mounted within the housing, bearing one or more of a laser, ink pen or inkjet print head, for adding surface decoration onto the dispensed printing material.

Preferably, the print head and utility head are both mounted onto a common platform.

According to another aspect of the present invention, there is provided a 3D printer, comprising:
a housing providing a printing chamber;
a print bed at the base of the printing chamber, the print bed comprising one or more apertures;

a pump device, for drawing air through the apertures, to generate a vacuum beneath an object located on the print bed to retain it in position; and
a utility head, movably mounted within the housing, bearing a cutting tool for cutting the object on the print bed while it is retained in place by the vacuum generated beneath it.

According to another aspect of the present invention, there is provided a 3D printer, comprising:
a housing providing a printing chamber;
a print bed at the base of the printing chamber, the print bed being tiltable; and
a print head, movably mounted within the housing, for dispensing a printing material while the print bed is horizontal or tilted with respect to the horizontal.

The 3D printer may comprise a plurality of pillars, each pillar having a bed carriage arranged to move vertically on the pillar;
wherein the print bed is movably mounted within the housing via the bed carriages of the plurality of pillars, and is tiltable by moving the bed carriages independently of each other.

According to another aspect of the present invention, there is provided a 3D printer, comprising:
a housing providing a printing chamber; and
a dual liquid print head, movably mounted within the housing, for dispensing a liquid;
wherein the dual liquid print head comprises a first liquid print head and a second liquid print head each comprising a pump for drawing liquid from a hopper and dispensing it from a respective outlet; and
wherein the dual liquid print head is configured such that as the pump of the first liquid print head draws liquid from the hopper (and dispenses it), the pump of the second liquid print head draws fluid into its respective outlet (from outside the print head). It will be appreciated also that the dual print head configuration may permit the pump of the second liquid print head to draw liquid from the hopper (and dispenses it), while the pump of the first liquid print head draws fluid into its respective outlet (from outside the print head). In other words, either liquid print head can be used both to dispense liquid, or create a vacuum (suck).

The hopper may be pressurised, for example using an air pump.

The 3D printer may comprise a print bed at the base of the printing chamber for receiving a mould to be filled by the dual liquid print head, the mould having a first opening and a second opening at a predetermined relative position with respect to each other, wherein the dual liquid print head is operable to be positioned with respect to the mould such that the first liquid print head dispenses liquid into the mould via the first opening while the second liquid print head creates suction through the second opening.

The pumps of the first and second liquid print heads may be driven by a common motor. In this case, the pumps of the first and second liquid print heads may be cavity pumps comprising a rotor and a stator, and the common motor may be configured to drive the rotors of the respective pumps in opposite directions simultaneously.

Each of the first and second liquid print heads may draw liquid from a different hopper. In this case, the respective hoppers of the first and second liquid print heads may contain different liquids.

In some cases, at least part of the first liquid print head and the second liquid print head are interchangeable.

In some cases, as the pump of the second liquid print head draws fluid into its respective outlet, this drives air into the hopper thereby pressurising it.

It will be appreciated that various individual features and combinations thereof provide an enhanced capability 3D printer, and address certain disadvantages of the prior art. For example, the combination of FDM printing, liquid printing and UV curing enables a solid, hollow object to be printed and filled with liquid, and then the liquid cured to form a composite object. It will be appreciated that the liquid may be cure not only with uv light, but instead by heat, solvent evaporation or chemical reaction. The further introduction of a vacuum (either in the printing chamber as a whole, or specifically within the FDM printed object) enables such a composite object to be formed more effectively (more reliable filling of the object with liquid, with fewer air bubbles). A combination of a twin molyneux vacuum pump print head, FDM, print head, vacuum bed and laser, ink pen and enclosed sealed enclosure enables complex composite products to be formed with a single 3D printer with minimal human interaction.

### BRIEF DESCRIPTION OF THE DRAWINGS

Embodiments of the present invention will now be described by way of example only with reference to the accompanying drawings where like parts are provided with corresponding reference numerals and in which:

FIGS. 1A to 1F schematically illustrate a 3D printer comprising various features of the present invention;

FIGS. 2A and 2B schematically illustrate a twin molyneux vacuum pump;

FIGS. 3A and 3B schematically illustrate vacuum pump arrangements' FIGS. 4A to 4C schematically illustrate a vented hot bed;

FIGS. 5A to 5H schematically illustrate a filament drive mechanism;

FIGS. 6A to 6D schematically illustrate a filament elevator;

FIGS. 7A to 7D schematically illustrate a magnetic carriage; and

FIGS. 8A and 8B schematically illustrate a vented print head.

### DETAILED DESCRIPTION

Overview

The present technique provides a novel combination of technologies to allow (for example) 3D printing of encapsulated electronics and rubber mouldings in combination with plastic printed parts. Current 3D printers operate using either FDM (fused deposition modelling), SLS (selective laser sintering), SLA (stereolithography) or metal printing to print items that are limited to the material range of the printer. These printed parts may contain moving mechanisms, but generally not to the extent necessary to manufacture finished items without significant further processing once the 3D printing process has been completed. Most products desirable for printing contain solid parts, electronics and mechanisms. Some products combine solid and rubbers for example to create rubber over-moulding such as a grip on a tooth brush. Current 3D printers do not offer the printing of liquids, although printers have been built that can print curing materials. As an example of the limitations of existing 3D printing techniques, no existing 3D printer combines the necessary methods to print finished products such as a WiFi operated toy car.

By combining fluid injection printing with fused deposition modelling (FDM), or other solid printing method, in the manner described below, moulded products housing encapsulated electronics can be printed (note that the 3D printer does not print the electronics, but may “print around” the electronics, with the electronics being manually or automatically inserted before or during the printing process). Certain of the techniques described herein allow for waterproof products to be manufactured, for example by printing rubber materials around printed solid plastic parts (the printed rubber materials may for example be deposited in liquid or gel form and cured to form an elastic/rubber material). The use of liquid deposition while simultaneously drawing air from the mould (either generally evacuating the printing chamber, or preferably more directly applying a vacuum to, at or in, the mould) makes the injection of liquids/resins more effective than simply relying on gravity. In particular, using a vacuum, areas of the mould above the gravity limit can be filled by sucking out the air from the mould, and thus drawing resin into these areas of the mould.

By providing one or more of an ink pen, ink jet, laser and vinyl cutter, it is possible to implement additional processes to bring the printed part(s) to a finished product state. These additional tools could (for example) be mounted onto the print head platform, such that the horizontal and vertical position of these tools can be controlled in an analogous manner to the print head. A CNC router could be added to allow for the removal of material, although care would be required to avoid clogging the vacuum inlets and air outlets which will be described below. Items can be placed on the print bed and filled with liquid, and/or graphics/artwork added by laser, or FDM printed on the items. This could entail printing an outline perimeter or other markings onto the print bed and placing the item within the printed perimeter (either manually, or with a robotic arm), to achieve accurate alignment and ensure that the artwork is printed on the item at a desired position. If the perimeter or markings are 3D printed rather than simply defining a visual guide, the resulting raised outline would assist with alignment, since the object would be retained in place. The same principles could apply for locating vinyl at a desired position to be cut. By way of example, the outline of a phone may be printed and raised letters added or text laser engraved thereon.

Having a light weight print head means less likelihood for backlash, overshoot, and frame wobble, all of which may cause inconsistent printing.

Overall Structure and Vacuum Chamber

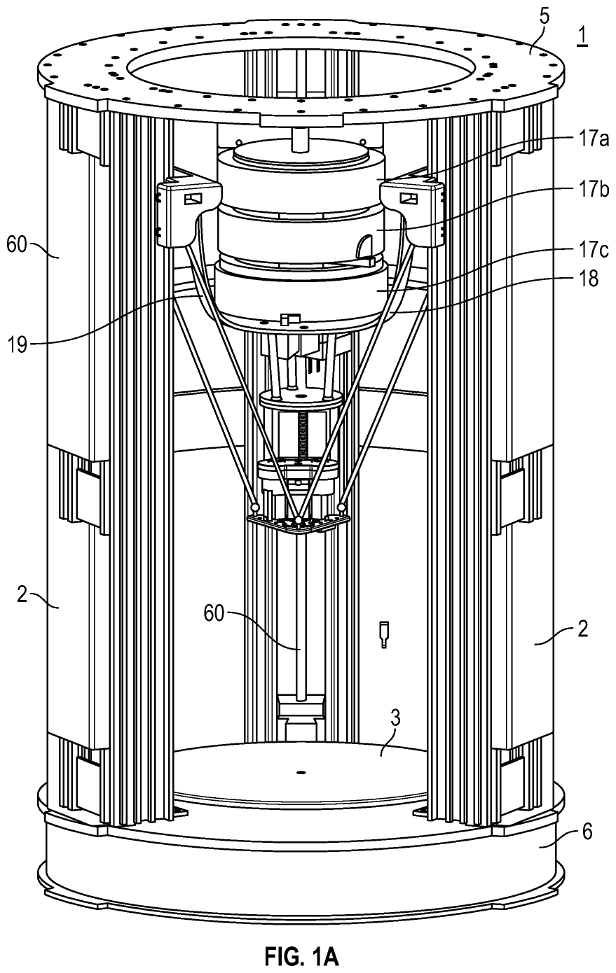

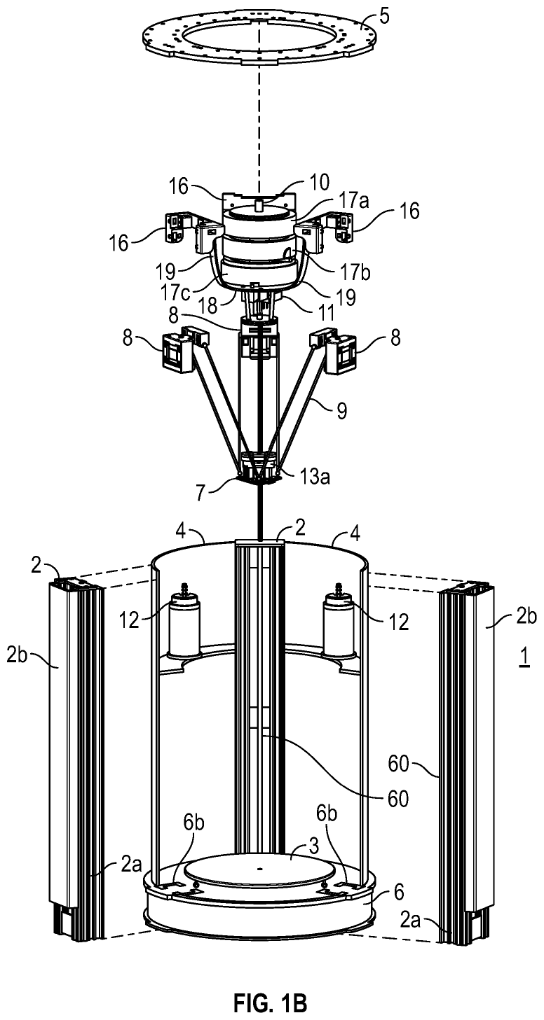

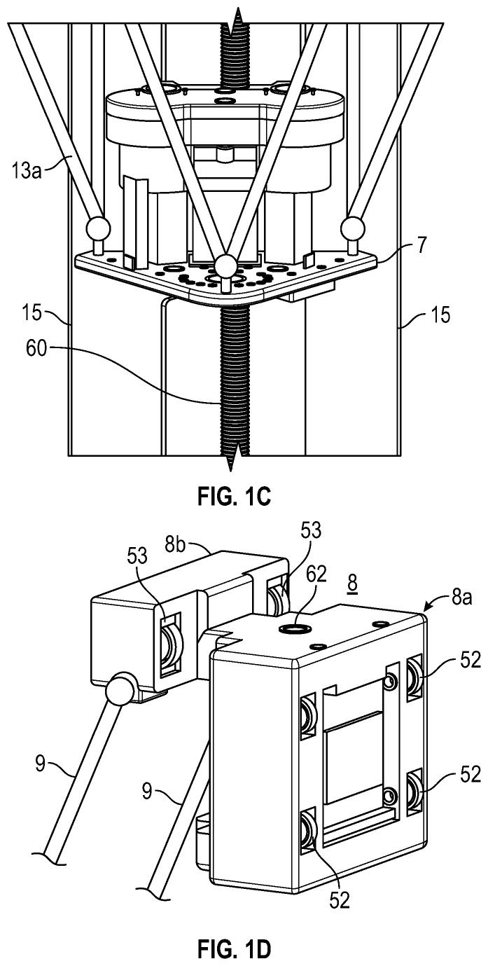

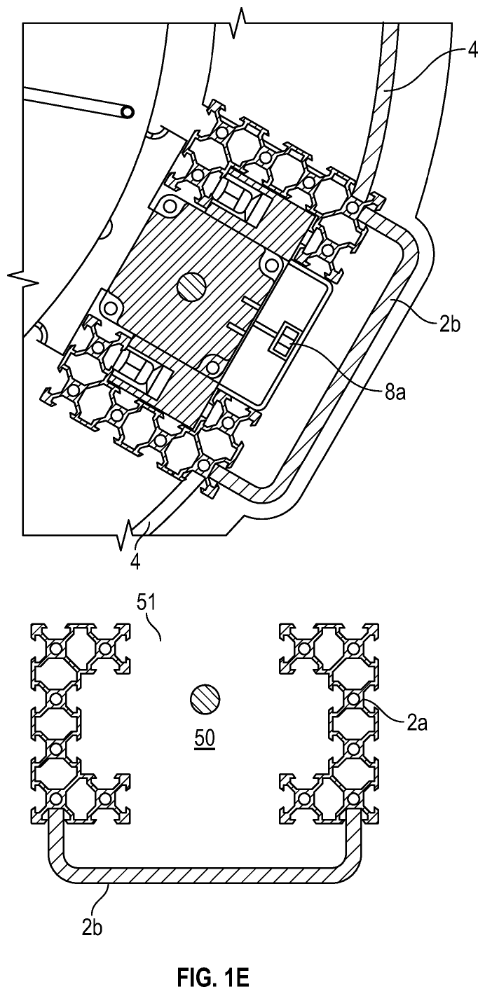

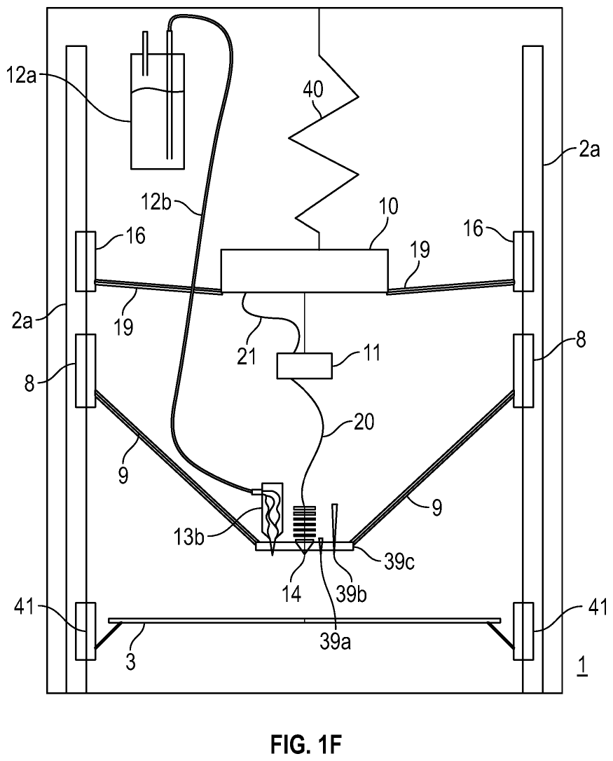

FIGS. 1A and 1B show the 3D printer as a whole, in an assembled view and exploded view respectively. FIG. 1C shows a close-up view of the circular portion ‘C’ marked in FIG. 1A. FIG. 1D shows a close-up view of the circular portion CA′ marked in FIG. 1B. FIG. 1E shows a cross sectional view of a vertical pillar (described below), both in situ (top drawing), and separately (bottom drawing). FIG. 1F is a schematic side view of the printer as a whole, emphasising different features, and demonstrating several variations on the design. Generally, in FIGS. 1A to 1F, a 3D printer 1 is shown arranged in a delta configuration. The 3D printer 1 carries both an FDM (fused deposition modelling) print head which melts filament material at a diamond hot end to be deposited in the printing process, and also a liquid print head (nozzle) which dispenses liquid from one or more hoppers.

In FIGS. 1A to 1E, a dual liquid print head 13a is provided, including two nozzles 15 which dispense liquid from two separate hoppers 12. In contrast, the 3D printer of FIG. 1F comprises a single liquid print head 13b which dispenses liquid from a single hopper 12a. The liquid print head 13b draws liquid from the hopper 12a through a tube 12b. It will be understood that many of the techniques described within the present application may be applicable to 3D printing techniques other than liquid printing and FDM. In particular, some of the printing techniques described herein may be applied to a 3D printer having a first and second print heads of different types. Preferably, the first print head prints a material which immediately, or following a short period of cooling, forms a solid, while the second print head dispenses a liquid, which may be solidified by way of a subsequent treatment such as UV curing. Some of the printing techniques described herein may require only a single print head.

Referring to FIG. 1C, the two print heads of the dual liquid print head 13a are more clearly visible, as are the nozzles 15 which are directed downwardly towards the print bed 3. The print heads can be seen to extend through a vented platform, which will be described inn more detail below.

The delta configuration comprises three vertical pillars 2 located around a print bed 3, the print bed 3 being provided on an upper surface of a base 6. The vertical pillars 2 mount into the base 6 via mounting slots 6b. The pillars 2 each comprise a linear rail 2a disposed inwardly of the printer 1, and a trim 2b disposed outwardly of the printer. Curved side panels 4 extend between (and slot into the sides of) each pair of the three pillars 3 to form a generally cylindrical enclosure. An upper circumferential panel 5 rests on the tops of the three pillars 3, and forms an outer, annular, portion of a roof of the printer 1. The central opening within the annular portion 5 can be covered with a central roof portion (not shown) in order to define a fully enclosed printing chamber between the pillars 3, side panels 4, print bed 3/base 6 and the roof. The printing chamber is preferably both fully enclosed, and sealed (or sealable), such as to permit a vacuum to be formed within the printing chamber if desired.

A print head platform 7, bearing one or more print heads/nozzles is suspended from three printhead carriages 8, each printhead carriage 8 being mounted to a respective one of the pillars 2 via (two) connecting rods 9. The carriages 8 are independently movable up and down their respective pillars. This allows for movement of the print head platform 7 (and thus 3D printing) in an x, y (horizontal) and z (vertical) direction. In particular, any vertical and horizontal printing position of the print head platform 7 within the chamber is achievable by way of selecting the appropriate vertical position for each of the carriages 8. While FIGS. 1A and 1B show all three printhead carriage 8 and pillars 2, for simplicity, FIG. 1F is shown with only two pillars 2 and their respective carriages 8.

Referring to FIG. 1D, each printhead carriage 8 comprises a first part 8a and a second part 8b. The connecting rods 9 are connected to the second part 8b. The first part 8a and second part 8b are detachably engageable with each other, as shown. Referring to FIG. 1E (bottom) a cross section through one of the pillars 2 is provided, showing the linear rail 2a and the trim 2b. Various longitudinal slots are provided both externally and internally of the rail 2a. An internal region 50 is provided, which has an opening 51 inwardly towards the printing chamber, opposite to the trim 2b. Referring to the upper part of FIG. 1E, it can be seen that the first part 8a of the carriage 8 is provided within (and movable vertically within) the internal region 50. The second part 8b of the carriage 8 then engages with the first part 8a through the opening 51, such that both parts 8a, 8b of the carriage 8 are movable vertically on and in the rail 2a. The part 8a comprises wheels 52 which engage with, and permit movement along, the inside of the linear rail 2a. Similarly, the part 8b comprises wheels 53 which engage with, and permit movement along, the outside of the linear rail 2a. It can also be seen in the upper part of FIG. 1E how the panels 4 fit into external channels/slots in the linear rail 2a. The carriages 8 may be caused to move vertically (upwardly and downwardly) on the linear rail 2a by any suitable means. In FIGS. 1A, 1B and 1C, a threaded lead screw 60 extends vertically within each of the columns 2. The threaded lead screw also extends through an internal (partially or completely) threaded bore (not shown) in the part 8b of the carriage (see aperture 62). In one implementation, a motor is provided within each of the pillars (for example mounted at or within the base of the 3D printer) which causes the screw within that pillar to rotate. As the screw rotates, its rotation within the threaded bore of the carriage 8 causes the carriage to move upwardly or downwardly within the pillar (depending on the direction of rotation of the lead screw 60). In an alternative version, the lead screw 60 is fixed (does not rotate), but a motor is provided within the part 8a of the carriage 8, which is able to rotate a threaded sleeve about the fixed lead screw 60, causing the carriage 8 to move upwardly or downwardly within the pillar. An advantage of the latter arrangement is that if further carriages are provided within the same pillar (for example the tilting print bed carriages described below), these can be operated independently.

A filament elevator 10 is located above the print head platform 7, and carries (in this example) three different filament spools 17a, 17b, 17c. The filament elevator 10 is mounted to the three pillars 2 via three respective elevator carriages 16, which are rigidly connected to each other, and to the elevator 10. The filament elevator 10 may be considered as a platform 18 having three arms 19, each of which attaches to one of the elevator carriages 16. The three filament spools 17a, 17b, 17c are located on the platform 18. The filament spools 17a, 17b, 17c each carry a respective filament which can be melted at a hot end 14 to be deposited by the 3D printer 1. More specifically, each filament spool 17a, 17b, 17c stores a filament of a particular colour or material.

A filament drive mechanism 11 is suspended beneath the filament elevator 10 and is operable to pull filaments from each of the spools of the filament elevator 10 and deliver them to the print head platform 7, and in particular to and through the diamond hot-end 14 (see FIG. 1F) which is able to melt the filament material and to deliver it to an appropriate position within the printing chamber to print an object. The spools 17a, 17b, 17c are rotatably mounted on a spindle (not shown), and are able to rotate independently from each other, such that as the drive mechanism 11 pulls a filament from the spool 17a (for example), the spool 17a is causes to rotate to release the filament, while the spools 17b, 17c may remain stationary. As will be discussed further subsequently, the drive mechanism 11 may draw filaments from two or more of the spools 17a, 17b, 17c simultaneously, at the same or different rates. A tube 20 extends (at least part of the way) between the filament drive mechanism 11 and the diamond hot-end 14, through which the filament passes. The tube 20 protects the filament and reduces kinking during its delivery. Similarly, a tube 21 extends (at least part of the way) between the spools 17a, 17b, 17c to the drive mechanism 11, through which the filament passes.

Also mounted on the printhead platform 7 is a (twin) moineau pump 13a (or single pump 13b in the case of FIG. 1F) which is fed with fluid from a hopper 12, the latter being located on shelves formed on the side panels 4, above the maximum upper position of the print head platform 7, both to avoid providing an obstruction inside the effective printing area, and so that gravity can assist the provision of fluid from the hopper 12 to the print head platform 7. The moineau pump 13a, 13b allows for fluids to deposited directly on the print bed 3 or inside an object located on (and optionally printed on, for example using the FDM print head) the print bed 3. The print head platform 7 may be vented to control the temperature at the print head(s). The print bed 3 is (or comprises), in some embodiments, a vented hot bed. A UV light source and one or more of a laser, ink printing mechanism, vinyl cutter or router may also be provided. One or more of these could be readily mounted onto the print head platform 7, or might alternatively be mounted elsewhere (for example on a utility platform). Alternatively, the print head platform 7 might be interchangeable with a utility platform bearing one or more of these tools. A UV light source could be mounted on one (or more) of the shelves of the side panels 4, along with the hopper 12.

In FIG. 1F, the printhead platform 7 can be seen to carry the hot-end nozzle 14 in addition to the liquid print head (Moineau) pump 13b. An inkpen 39a, laser 39b and vinyl cutter 39c are also disposed on the printhead platform 7. Only a single liquid hopper 12a is shown in FIG. 1F. The hopper 12a is a sealed container, which can be evacuated (a vacuum formed therein) or pressurised via a pump/vacuum which is in fluid communication with the interior of the hopper 12a via an inlet/outlet. A filament elevator counterbalance mechanism 40 is shown in FIG. 1F. This suspends, or supports, the filament elevator 10 from above, and in particular from the roof of the 3D printer 1. In this way, some (and preferably a majority) of the weight of the filament elevator 10 is borne by the counterbalance mechanism 40, making it easier for the carriages 8 to (in some cases singly) move the filament elevator up and down, as will be described in detail below. The counterbalance may comprise springs or elastic which connect between the roof 5 and the elevator at three or more points. A pulley arrangement may be provided, if required.

In FIG. 1F, print bed carriages 41 are provided which are able to move vertically on the vertical columns 2 to reposition and/or tilt the print bed 3. The print bed carriages 41 are of similar form to the print head carriages 8, and may be mounted within, and movable within the columns in the same or a similar manner to the carriage 8, for example in how they are mounted to the lead screw 60. The print bed carriages 41 are connected to the print bed 3 at three positions around its circumference. It will be appreciated that with three carriages 41 on the three columns 2, it is possible to achieve any direction of tilt of the print bed 3 (which as discussed later, may be a hotbed). In particular, the vertical height of the print bed 3 at the three positions around its circumference can be controlled to influence the gradient and direction of tilt of the print bed 3. This allows printing (3D or 2D using an inkjet print head or pen) on surfaces which would not be horizontal for a horizontal print bed, either on an FDM printed object already laid down by the 3D printer, or an item placed manually on the bed. It also makes it possible to use a laser to smooth (bevel or chamfer) layered edges. More generally, a tilting hotbed/print bed makes it possible for a for laser, CNC, ink pen inkjet print head or FDM nozzle to be positioned to print on an item in the printer that would not otherwise be parallel to the print head platform. For example, an item could be printed then tilted to print on the previously angled surface. Since the surface is tilted the layering of the FDM would make for better printed letters. As an example of operation, first a location perimeter matching the shape of an item can be printed onto the print bed, then the item can be placed within the perimeter and printed on (the perimeter prevents the item from sliding down the inclined surface of the print bed once it has been tilted). The tilting of the print bed also allows for graphics to be printed on a curved surface by simultaneously tilting the print bed and moving the print head. It will however be appreciated that the print bed can only be tilted a small amount without interference between the print head and the object to be printed and/or the print bed.

From the above explanation, it will be appreciated that, by fixing the print bed to 3 points that can move up and down, it is possible for the print bed to be levelled and tilted. A level print bed is important for consistency whilst FDM printing. If the 3D printed is placed on a surface which is not completely level, the print bed may be adjusted to compensate for with. An auto-levelling function could be provided, or a spirit level or similar integrated into the print bed to enable levelling by eye. As discussed, intentional tilting of the print bed allows for printed parts having an angled upper surface (not horizontal to the printbed) to be tilted so as to make them horizontal. This allows for tools mounted on the printhead platforms to work on a horizontal surface, or allows for further printing on the now-horizontal upper surface of the printed object. It is also possible to control the angle and direction of tilt of the print bed during a printing process, under the control of a software algorithm, to (for example) enable the twisting of the bed in a circular motion in combination with a print head movement to create patterns, art or engraving both on horizontal surfaces or any other surfaces within the limits of tilt to be worked upon.

The use of a vacuum chamber and hot bed that blows air into the printing chamber allows for the chamber to be heated whilst printing FDM and the provision of a vacuum environment while using liquid resins. The vacuum function also removes harmful solvents and other unwanted smells or smoke from the chamber, such as those produced by the use of a laser. The 3D printer may use a compressor/vacuum pump and pneumatic valves to control and or change the use of the pump through a bank of pneumatic solenoid valves.

Twin Moineau Vacuum Pump

As discussed above, benefits can arise from evacuating air from the printing chamber. Further benefits may arise from more directly evacuating air from a mould or other object into which liquid is being printed/dispensed. This may be achieved by way of a liquid print head (for fluid injection printing) in combination with a vacuum inlet in the general vicinity of the liquid print head for drawing air out of the mould or object while liquid is being dispensed into the mould or object. This may for example be achieved by providing two openings into the mould, with filling of the mould with liquid being carried out by aligning the liquid print head with a first of the openings and the vacuum inlet with the second of the openings, and drawing air from the second opening (to create a vacuum, or at least draw some of the air from the mould) at the same time as dispensing liquid into the first opening. The first and second openings, and the liquid print head nozzle and vacuum inlet, may be dimensioned such that the liquid print head nozzle generally or substantially fills or covers the first opening (or even provides a complete seal) while the vacuum inlet generally or substantially fills or covers the second opening (or even provides a complete seal). Referring back to FIG. 1C, it will be appreciated that this could be achieved by removing one of the liquid print heads and in particular by replacing the associated nozzle 15 with a vacuum inlet.

Conventional 3D printing heads such as paste extruders feed paste by loading a syringe, which is prone to trapped air. Some extruders use a container pressurised with air to force the paste out. The presence of air in the paste results in air being expelled instead of the paste, such that no material is printed. The use of Moineau pumps to extrude paste has been considered, and commercial form-in-place printers have a shutting valve. Syringes and bags are messy to fill. In contrast, the twin pump described herein uses a pressurised hopper, meaning that the fluid in the hopper can settle, while the pump draws the fluid from the bottom (where bubbles should be at a minimum once the fluid has settled, due to the tendency for bubbles to rise naturally in thin fluids). With more viscous fluids this advantage would be reduced, but still present. The hopper may have a vacuum applied thereto in order to remove more bubbles. The pump draws fluid as per all moineau pumps.

Proposed is a dual operated pump mechanism utilizing two screw positive displacement stators pumps (moineau pumps). An air pressurised hopper feeds fluid into one of the pumps, so as to dispense accurately metered amounts of fluid onto the print bed. In combination with a UV light, the dispensed fluid can be cured in specific locations on the print bed in a similar fashion to FDM. The other pump can be used to print a different colour or material. When used for mould filling, the first pump may be utilized for pressurised injection of the liquid into the mould while the second pump is utilised for vacuuming the injected fluid through the mould and/or to de-gas the injected fluid. The hopper may be primed by evacuating air or gas from it prior to printing. Once the pump and hopper are purged of air (or other gas), little or no gas and bubbles are contained within the fluid leading to better prints and moulding. The pump utilizes “luer” lock tips, which offer the advantage of being available in multiple designs of tip size and angles so that fluids of different viscosities can be printed consistently. The twin Moineau vacuum pump has easily changeable pump chambers and stators. As a result, if a fluid should cure inside the pumping chamber, the chamber and/or stator can be quickly swapped with a replacement to minimise down-time. The pump mechanism prevents fluids from entering the drive mechanism, so that the pump stator can be driven reliably without the drive mechanism being fouled with the liquid.

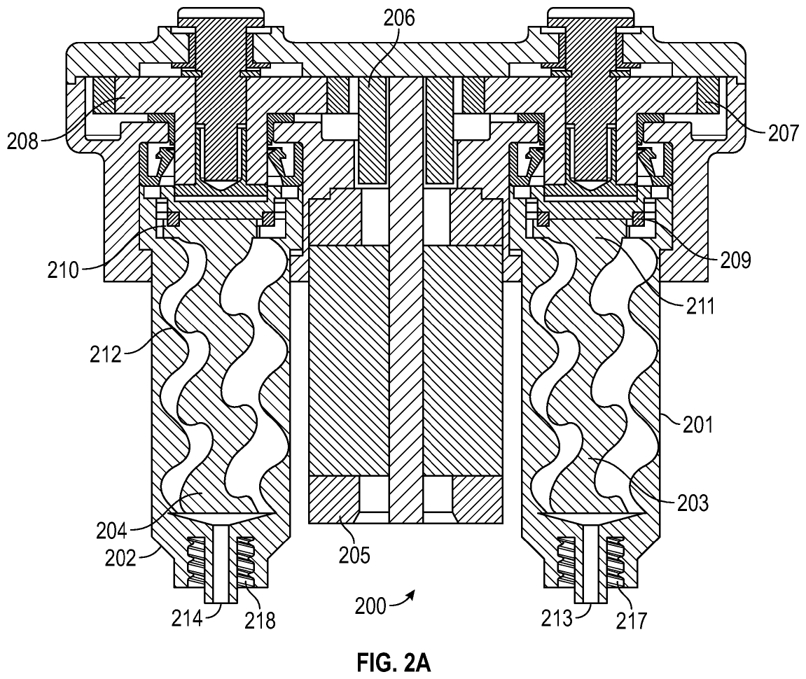

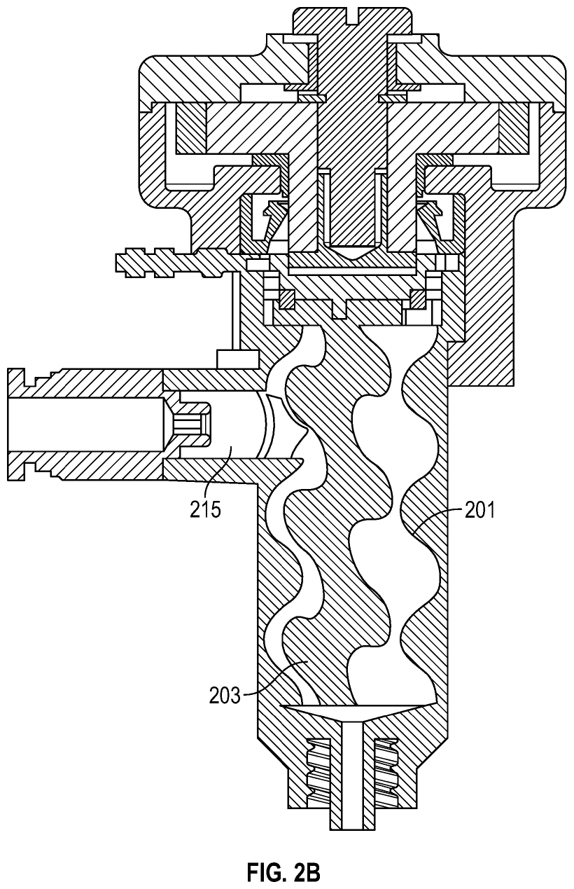

In FIG. 2A, a twin moineau pump 200 is shown. Two pumps are provided, each of which is a cavity pump comprising a stator 201, 202 within which rotates a rotor 203, 204. Cavities are defined between the stator 201 and rotor 203 of the first pump (due to the external shape and dimensions of the rotor 203 and the internal shape and dimensions of the stator 201), and these cavities effectively progress longitudinally as the rotor 203 rotates, driving the contents of each cavity towards and out of a nozzle 213. The nozzle 213 is mounted onto the pump using a luer lock tip thread 217, permitting ready replacement of the nozzle. In FIG. 2B, a side view of the twin moineau pump is shown, in which a fluid inlet 215 can be seen to permit fluid to enter the cavities between the stator 201 and rotor 203. The fluid inlet is in fluid communication with the hopper 12. As the cavities (and the liquid within them) progresses away from the inlet 215 towards the nozzle 213, this creates a vacuum in the vicinity of the inlet 215. This generates a pressure difference between the vicinity of the inlet 215 and the hopper 12 (which is accentuated if the hopper 12 is pressurised), causing the fluid from the hopper 12 to be drawn towards the inlet and into the cavities between the stator 201 and rotor 203. Similarly, cavities are defined between the stator 202 and rotor 204 of the second pump, and these cavities effectively progress longitudinally as the rotor 204 rotates, driving the contents of each cavity towards and out of a nozzle 214. The nozzle is mounted at the end of the pump using a luer lock tip thread 218, permitting the nozzle 214 to be replaced (for example with a nozzle of a different dimension). An inlet (not shown) is provided, in like manner to the inlet 215 of the first pump.

Returning to FIG. 2A, the progressive cavity pumps each operate by rotation of their respective rotors 203, 204 under the action of a shared stepper motor 205 driving a shared drive gear 206. The drive gear 206 in turn drives the first and second rotor drive gears 207, 208 of the first and second pumps respectively. The first and second drive gears 207, 208 drive respective offset drive plates 209, 210. The offset drive plates 209, 210 have a pin which is offset from the centre of the drive plate which engages with rotor drive plates 211, 212. The pins locate in the rotors 203, 204 to allow for the offset rotation of the rotors 203, 204.

As mentioned above, the rotation of the rotors 203, 204 transfers fluid by progressing a sequence of discrete cavities. It will be understood that the flow rate is proportional to the rotation rate of the rotor, enabling the flow rate to be easily controlled. It will also be appreciated that only one rotational direction of a rotor will cause liquid to be dispensed through the nozzle. When the rotor is rotated in the opposite direction, air will be drawn in through the nozzle of the pump, and pushed out through the inlet and towards the hopper 12. The same motor is used to drive both the rotor 203 and the rotor 204 at the same time (and at the same speed), and the arrangement of gears 206, 207, 208 causes the rotors 203 and 204 to rotate in the same direction. In this example the two pumps have opposite geometries (or handedness) in terms of the progressive cavity actions provided by their respective stator and rotor, and so the driving of the motor will cause a first of the pumps to dispense liquid from the hopper 12 with which the first pump is in fluid communication, while simultaneously second of the pumps to draw air in through its nozzle and towards the hopper 12 with which the second pump in is fluid communication. This makes it possible to pressurise a hopper 12 using the same drive process as dispensing fluids. In an alternative embodiment, the pumps may have the same handedness, but be caused to contra-rotate by the inclusion of an intermediate gear, thereby achieving the same effect of being able to dispense fluid with one pump while drawing air in with the other.

The liquid is therefore pushed from the top of the first pump to the bottom of the first pump and out through the nozzle 213. When the stepper motor 205 is caused to rotate clockwise (for example), the resultant clockwise rotation of the gear 206 will cause the gear 207 to rotate the pump rotor 203 counter clockwise creating a pumping action. This causes fluid to be drawn in through the pump inlet 215. Simultaneously the pump rotor 204 will be rotated by its gear 208 and drive plate 210 creating a vacuum action sucking through nozzle 214 and expelling through the inlet 215, due to the opposite handedness of the cavity structure created between its rotor and stator when compared with the first pump.

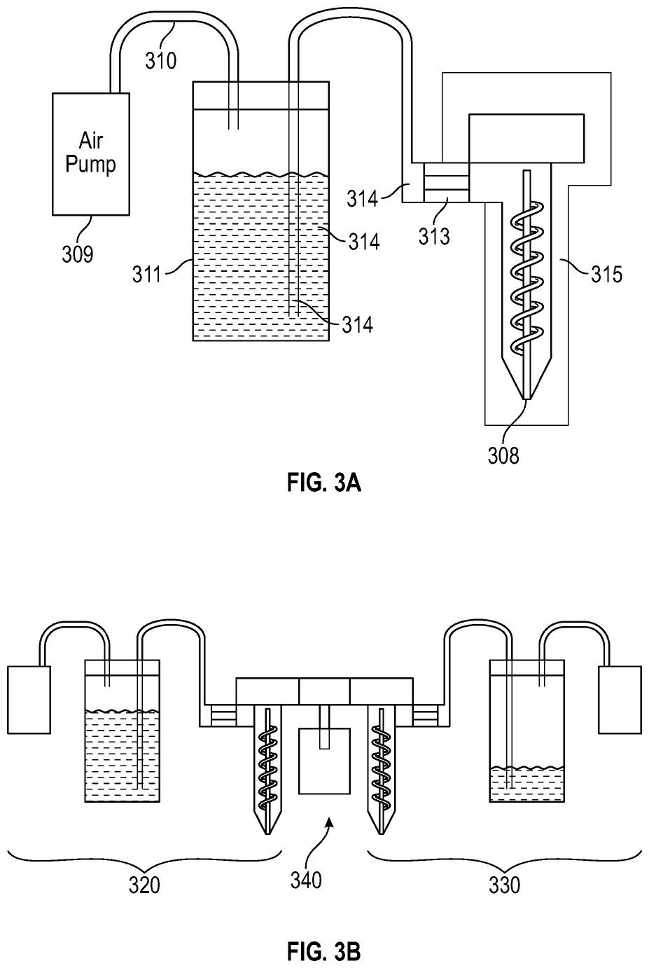

A single moineau pump using a pressurised hopper is shown in FIG. 3A. Fluid 314 for printing is contained within a hopper 311. An air/vacuum pump 309 feeds air through an air inlet 310 into the hopper 311, thus pressurising the hopper 311. A moineau pump 315 is provided. When the moineau pump 315 starts pumping, fluid is sucked through a hopper outlet 312 and into an inlet 313 of the moineau pump 315. The pressurisation of the hopper 311 aids this process, by increasing the pressure differential between the hopper outlet 312 and pump inlet 313. The fluid 314 is pumped by the progressive cavity action described above. This causes the fluid 314 to exit a nozzle 308 of the pump 315. By reversing the above action, the air pump 309 draws air (sucks) through the air inlet 310 whilst the pump 315 operates in reverse. This allows air or fluid to be sucked in by nozzle 308 through to the hopper. The air pump 309 may assist this process by reversing its operation to depressurise the hopper 311, or even to create a vacuum in the hopper 311. In another variation, the air pump 309 may not be used during the reverse operation, but a release valve (not shown) may be used to depressurise the hopper 311 to ambient pressure prior to operating the pump 315 in reverse.

FIG. 3B shows the pump/motor arrangements of FIGS. 2A and 2B in combination with the hopper/pump arrangement of FIG. 3A. Each of the land hand side and right hand side of FIG. 3B corresponds to an instance of the arrangement shown in FIG. 3A. However, the respective moineau pumps of the two instances are both driven (at the same time) by the same motor. This allows for 2 pumps and hoppers to be utilised in parallel with a single driving motor. The air pumps are both able to draw air from their respective hopper (vacuum mode) and pump air into their respective hopper (pressurise mode). The action of a common stepper motor 340 creates the necessary mechanical movement to drive both rotors, as outlined in FIG. 2A, for one pump and hopper (for example the left hand pump and hopper 320 in FIG. 3B) to act as a pump whilst the other pump and hopper (for example the right hand pump and hopper 330) in FIG. 3B) acts as a vacuum. Reversing the stepper motor would then cause the right hand pump and hopper 330 to pump while the left hand pump and hopper 320 sucks.

One advantage of the two moineau pumps driven by one motor is the reduced weight, which is important given that the pumps will need to be mounted onto the print head platform. Further, because the two pumps are driven together, one is able to suck while the other pumps. Both pumps can therefore operate as either a pump or a vacuum. The air feed line, either between the hopper and the dispensing pump, or between the air pump and the hopper, may be provided with a valve to shut when not printing to stop fluid dribbling. Appropriate selection of lure lock tip in relation to the fluid also aids preventing of dribbling. Because one pump sucks and the other pumps, the filling of a mould by liquid from one of the pumps can be aided by the sucking action of the other pump, as discussed above. In particular, the generation of a vacuum within the mould causes fluid to be more effectively drawn into all parts of the moult than by relying on gravity alone. The air compressor pump may use adjustable valves to set the flow rate depending on the type of fluid being used, and may run at a set level by PWM (pulse width modulation) to control the pressure. Relatively thin (non-viscous) liquid such as water requires lower pressure to pump compared with thicker, more viscous liquids such as silicones. The fluid in the hoppers can be degassed by running the vacuum for a short period after the material is loaded (this would be most effective if just one hopper was to be degassed).

Vented Hot Bed

A vented hotbed is provided inside the sealed chamber. The hotbed itself serves as the printbed discussed previously (and subsequently). The hotbed provides a planar surface onto which articles can be printed. The hotbed may be a metal or ceramic plate (or other suitable material) which is, or contains, a heating element. The vented hotbed uses a pneumatic operated vacuum to drive air into the chamber and/or draw air out of the (sealed) chamber. Presently available 3D printers use a heated bed to print on, and some of these enclose the printer to reduce heat loss. Heating the printing chamber creates a consistent ambient temperature for the build area and aids consistent printing by reducing shrinkage and warping (which may occur as the dispensed printing material cools on a print bed). Some 3D printers use fans to circulate the air. The proposed 3D printer improves upon prior designs by providing a vented bed having channels that are provided directly below the heating element. Air is fed through the channels, extracting heat from the bed to heat the chamber. The injection of heated air may be switched on and off in dependence on feedback from a temperature sensor or sensors within the printing chamber. By switching the direction of flow (from pumping air into the printing chamber to drawing air out of the printing chamber) it is possible to extract fumes and gases trapped in the liquid printed in a mould or in an open-top-enclosure can be drawn out. This is achieved using a pneumatic valve that directs air from the compressor pump. In vacuum mode the pump runs at its normal level (speed) and an adjustable valve and PWM (Pulse Width Modulation) of the pump motor are used to set the required sucking level.

The vented heat bed uses an air compressor to blow air into the heat chamber through the inlet the duct(s) in the bed, utilizing the heat from the heat mat to create a constant temperature in the chamber. The air duct directly below the heat mat allows for the heat exchange. In vacuum mode air is sucked from the chamber to enable degassing of liquids within a mould produced by the 3D printer (as discussed above in relation to a dedicated vacuum inlet on the print head platform, or as part of the dual pump). The vacuum also removes toxic fumes from the chamber. The toxic fumes may either be passed through a filter (and either recirculated to the chamber or exhausted to the outside) or exhausted directly to the outside air. The change from vacuum mode to pump mode may be achieved by any number of combinations of controllable valves.

FIGS. 4A to 4C show a vented hot bed 401. FIG. 4A shows the vented hot bed 401 mounted within a printing chamber 404 of a 3D printer, while FIG. 4B shows the vented hot bed 401 when viewed from above, and FIG. 4C shows the internal conduit structure of the vented hot bed 401. The vented hot bed 401 comprises a heat mat 403 directly fixed to its top surface. The heat mat 403 may be metallic, or ceramic, or any other suitable material, and may be electrically heated by an electrical power source (not shown). Items are 3D printed on top of print bed 403a mounted on the heat mat 403. While operating in a chamber heating mode a valve 411 is configured to allow an air compressor 412 to blow air through an inlet 409 into ducts extending past (or through) the heat mat 403 (in this example the ducts are provided below the heat mat 403) and thus extracting heat from the heat mat 403 on the way to the printing chamber, which it enters through the inlets/outlets 402. It will be appreciated that the ducts need only pass sufficiently close to the heat mat 403 to draw heat from it, they are not required to be immediately adjacent. In this way, the chamber is heated using air which is already at a high temperature at its point of entry into the chamber 404. A sensor 413 in the chamber 404 senses the temperature of the chamber and uses software/electronics to control the air compressor to be on/off as necessary to achieve the required temperature. It will be appreciated that a plurality of temperature sensors could be used, at different positions within the printing chamber 404. It will also be appreciated that the temperature within the chamber could also be controlled by increasing or decreasing the temperature of the hotbed itself. However, the temperature of the hotbed may be required to be within a predetermined range in order to serve its primary function in relation to maintaining the temperature of the printing material printed thereon, and so control via air flow is generally preferable.

To switch from heating mode to vacuum mode (note that the chamber, or at least the base thereof may still be heated using the heat mat 403 during the vacuum mode, but heated air will not be introduced into the printing chamber) the valve 411 is used to switch from connecting an air pump to the inlet 409 to connecting a vacuum pump to the inlet 409. It will be appreciated that, rather than providing separate air compressor and vacuum pumps, a single pump may be used and operated in two different modes. An item printed on the print bed 403 can be a mould item 407, enclosed on all sides apart from the top, or could have open vents on the top surface into which liquid could be dispensed. After liquid 406 is dispensed into the mould 407 it may contain unwanted trapped air 405. Furthermore, fumes 408 could be released (in this case from the liquid 406, but in other cases, from printed solid materials). The vacuum pump 412 applies a vacuum (negative pressure) at the outlet 409 and therefore sucks air from the chamber 404 through the duct 402 and via the inlets/outlets 402a. This causes negative pressure in the enclosure and as such air bubbles 405 contained in the liquid 406, and fumes 408 released into the chamber 404, to be removed and sucked through the air paths of the vacuum pump to outside or through a filter 410.

Referring to FIG. 4B, the upper part thereof provides a top view of the vented hot bed 401, in which the apertures 402a can be clearly seen, distributed about, and proximate to, the circumference of the upper surface of the hot bed 401. A central aperture 415 is also shown, which can be used to draw air from (create a vacuum within) an object having an (partially or fully) open bottom disposed over the aperture 415. The aperture 415 may be in communication with the pumps 412 in the same manner as the apertures 402a.

Referring to FIG. 4C, this is a cross section through the hot bed 401, in the plane of the ducts 402. Here, the ducts 402 can be seen to comprise a plurality of ducts which extend radially from a central internal area of the hot bed 401 (from which extends the inlet/outlet 409 to the pump 412) to each of the apertures 402a.

It will be appreciated that the vented hotbed provides one way of evacuating the printing chamber (alternative/additional ways are discussed above), as well as of heating the chamber more effectively. The vacuum could be achieved with just an inlet to the chamber, but the use of a vented hot bed gives the advantage that air can be blown into the printing chamber while taking heat from the bed to heat the chamber, and also by sucking through the bed multiple inlets may be used which defines a short distance for bubbles to travel to an inlet, irrespective of where the bubbles are located.

Filament Drive Mechanism

As discussed above, FDM 3D printers heat and melt filament(s) in the hot-end and extrude it through a nozzle. Filament drive mechanisms are used to drive the filament to the hot end (in the present case from the spools mounted on the filament elevator). Drive mechanisms are either mounted directly before the hot-end or remotely. The remote type drives filament directly to the drive mechanism through a tube. A diamond-hot-end takes (in the present case) 3 filaments and melts them through a single nozzle. Currently there are only single and double drive mechanisms available. Using 3 single drive mechanisms to feed the diamond hot-end makes the assembly large and requires mores space. Together, the diamond hot-end and filament drive mechanism are referred to as a filament extruder.

The present technique uses a smaller drive mechanism, enabling it to be mounted on or from the filament elevator. The print head platform 7 carries a diamond hot-end for melting the filaments delivered by the drive mechanism 11. The filament drive mechanism 11 in this case is a triple filament drive mechanism for delivering three separate filaments to the diamond hot-end. The drive mechanism 11 may deliver one or more of the filaments at a time, such that the diamond hot-end is able to melt either a single one of the filaments to form a printing material for deposition in the printing process, or a combination of two or more (in preferably adjustable proportions) of the filaments. The diamond hot-end takes the 3 filaments and melts them through a single nozzle so as to extrude 3 separate colours or different materials or a combination of these.

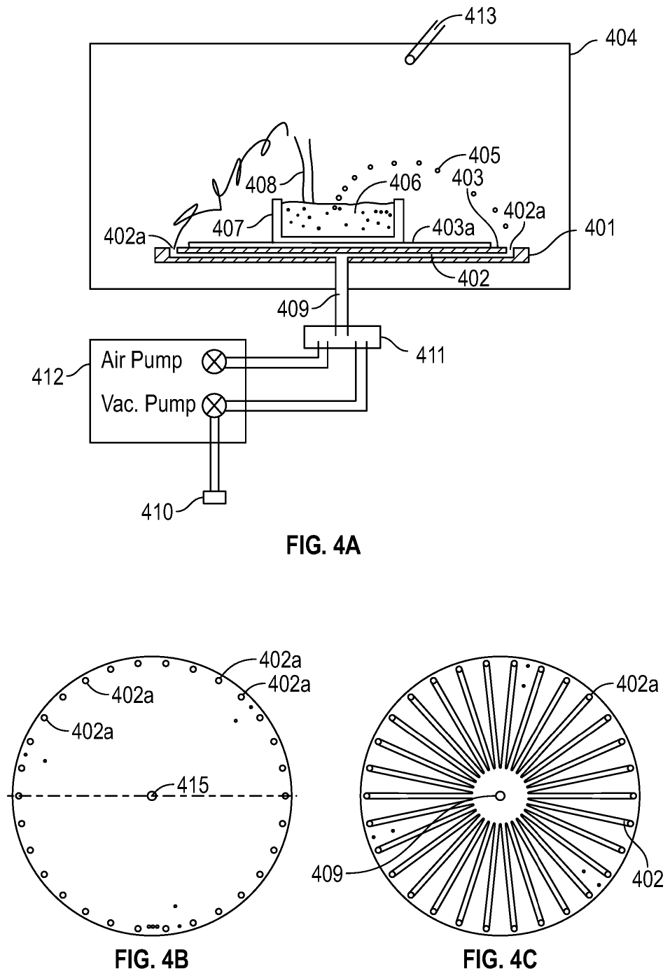

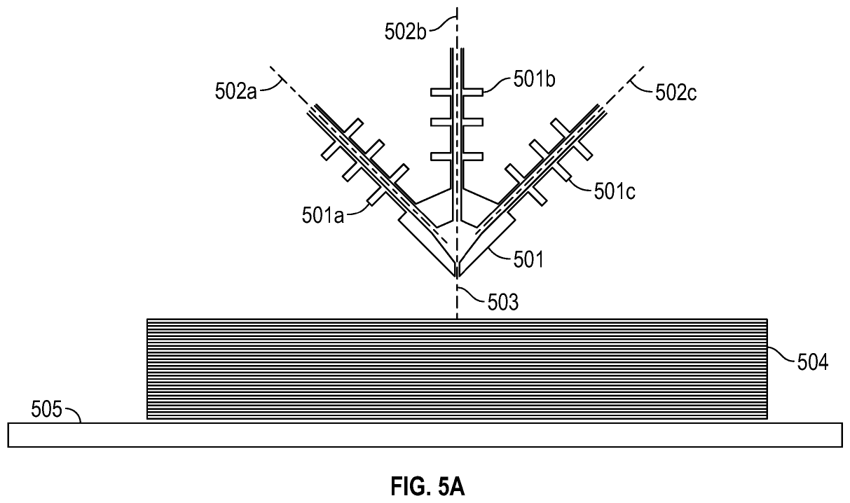

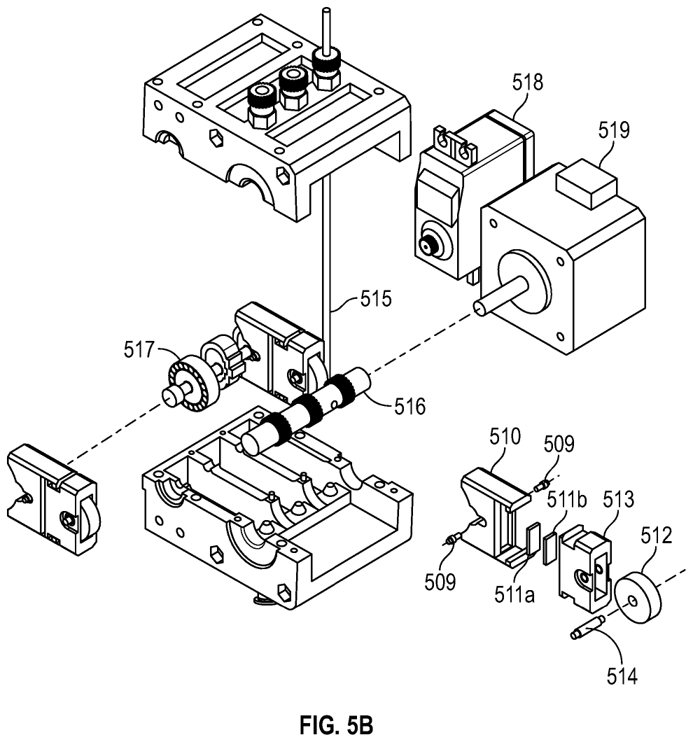

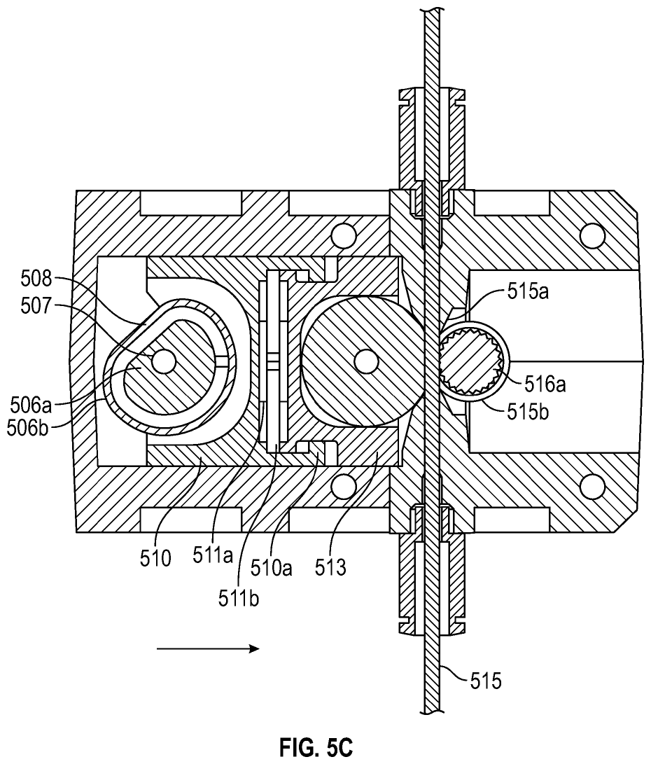

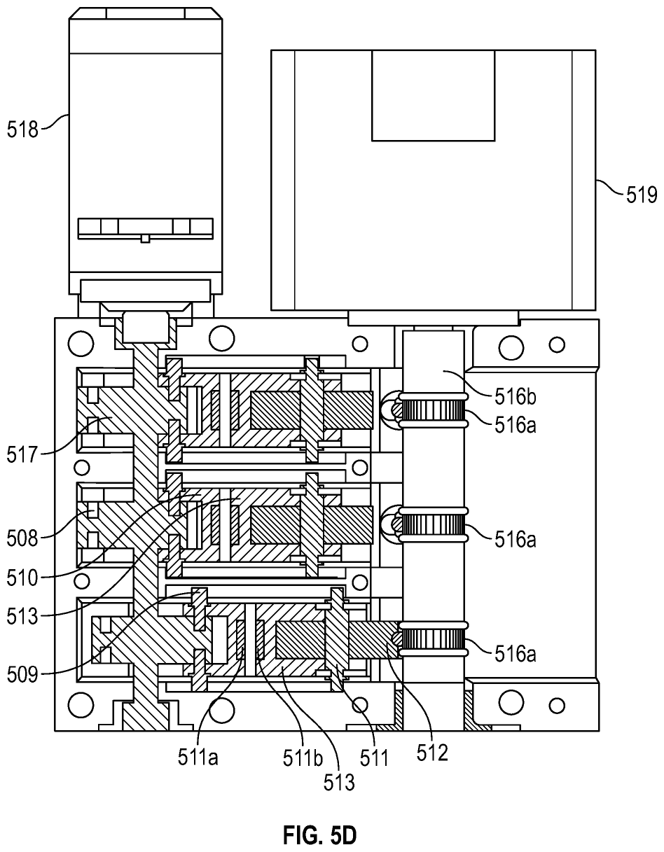

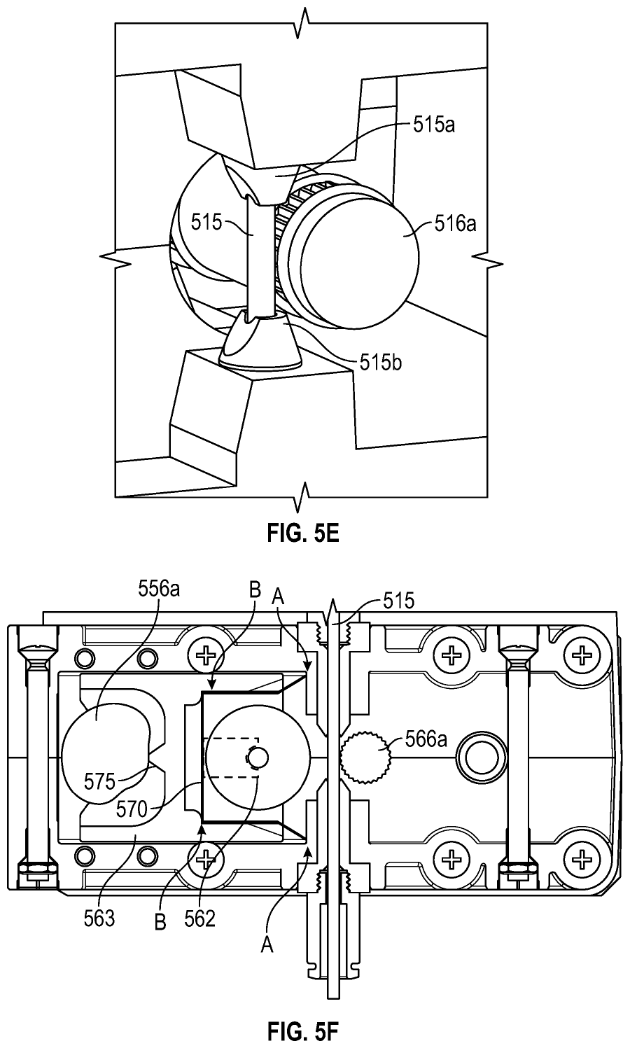

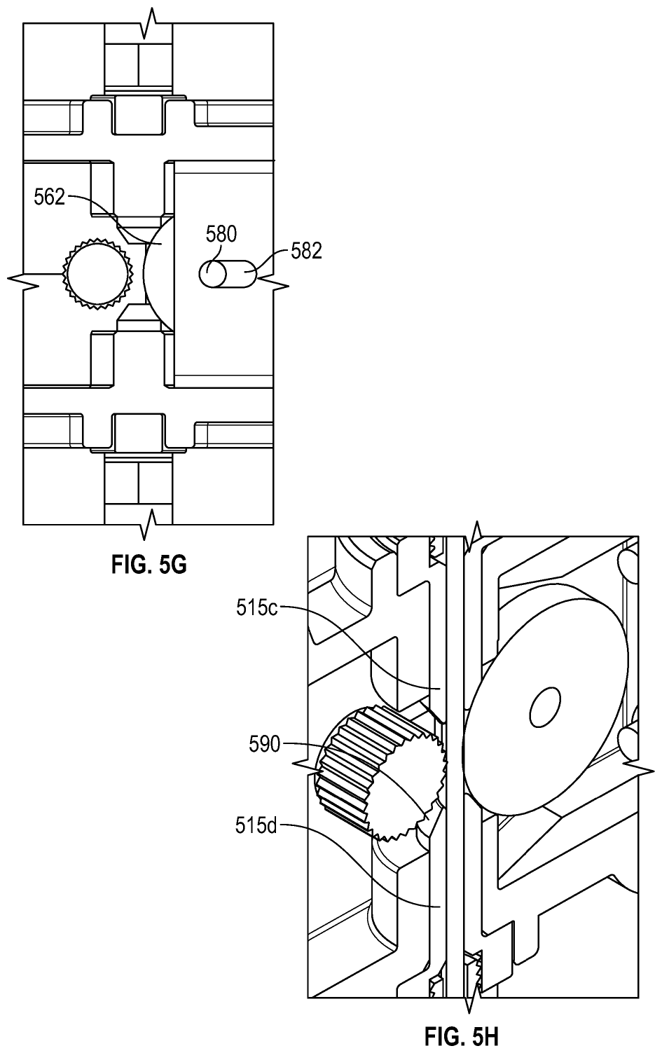

Referring to FIG. 5A, a diamond hot-end nozzle 501 is provided. The diamond hot-end nozzle 501 receives filaments 502a, 502b, 502c along three respective filament paths 501a, 501b, 501c. The filaments 502a, 502b, 502c are fed through tubes along the filament paths 501a, 501b, 501c from filament spools mounted on the filament elevator, to melt in the diamond hot-end nozzle 501. Then, melted filament material 503 leaves the nozzle and is deposited on the print bed 505 to form a 3D printed item 504. In order for the filaments 502a, 502b and 502c to be forced into the diamond hot-end nozzle, they need to be pushed (or fed) by a drive mechanism.

FIGS. 5B, 5C, 5D and 5E show a first suitable drive mechanism, taking the form of a triple drive mechanism which drives multiple (in this case three) filaments by use of a single stepper motor, and in particular enables the driving of 1, 2 or 3, or any combination of 1+2, 1+3, 2+3, 1+2+3 or 1, 2 and 3 by use of a cam system driven by a servo to engage the drive of the filaments. In particular, FIG. 5B is an exploded view of the drive mechanism, FIG. 5C is a cross section through part of the drive mechanism showing the parts that make up a single drive (of the triple drive), FIG. 5D is a cross section (perpendicular to that of FIG. 5C) which shows the triple drive in assembled form, and FIG. 5E shows a closer view of the channel through which a filament passes through the device. FIGS. 5F, 5G an 5H show a second suitable drive mechanism, having certain differences compared with the first drive mechanism. The example described herein is a triple extruder, having a cam which is driven by a servo, and which moves a cam follower. Referring to FIG. 5B, a single filament 515 is driven by filament drive teeth 516a. Pressure from a pressure wheel 512 allows for the filament to be driven. Upper and lower nipples 515a, 515b prevent the filament from kinking and feed the filament to the filament drive teeth 516a. The pressure wheel 512 engages and disengages from the filament 515 to apply or remove the pressure that allows the filament drive teeth 516a to engage with and move the filament 515.

The pressure wheel 512 may in some embodiments operate in two states—a first state in which it is fully disengaged from the filament 515 (or at least provides insufficient pressure for the drive teeth 516a to be able to engage the filament 515 strongly enough to drive it through the mechanism), and a second state in which it is fully engaged from the filament 515 (or at least provides sufficient pressure for the drive teeth 516a to be able to engage the filament 515 strongly enough to drive it through the mechanism). In alternative embodiments the degree of pressure exerted by the pressure wheel 512 may be controllably variable, so that the filament 515 is driven at a controllable speed through the mechanism, without needing to vary the speed of the stepper motor. This is beneficial, since the stepper motor can be operated at a constant (and predictable) speed, and different filaments can be driven through the mechanism at different rates by varying the amount of pressure being applied thereto by the respective drive wheel (effectively by controlling slippage). For example, five four states could be used; an “maximum” state providing a filament drive speed of 100%, an “off” state providing a filament drive speed of 0%, a “slow” state providing a filament drive speed of 25% and a “medium” state providing a filament drive speed of 50%. It will be appreciated that a smaller or greater number of speed settings could be provided.

The pressure wheel 512 is mounted in a pressure wheel carriage 513. On the rear of the pressure wheel carriage number 113a, a magnet 511b is provided. The pressure wheel carriage 513 is mechanically linked to a cam follower 510, such that the two components cannot move beyond a fixed separation from each other. A magnet 511a is provided on the cam follower 510 in a position proximate the magnet 511b. The magnets are magnetically opposed, to repel each other. The cam follower 510 controls the pressure wheel carriage 513 to move forwards and backwards between two positions, which may for example relate to the first and second states (or the “off” and “maximum” states) described above. a cam axle 507 forms a drive shaft which is driven by a stepper motor (not shown in FIG. 5B). A set of cams are mounted at different positions on the cam axle 507.

In FIG. 5B, which is a cross sectional view through the drive mechanism, only a single cam 506a (and the other components at the same cross-sectional position) can be seen. The cam 506a can be seen to comprise a pin groove 508, which generally follows the perimeter of the cam 506a, and in particular is between the cam centre 506a and its outer perimeter 506b. A pin 509 is shown to be located within the pin groove 508. The pin 509 is fixedly mounted to the cam follower 510, and both the cam follower 510 and the pin 509 are constrained to move only in a direction which is parallel (or anti-parallel) to the “Forwards” arrow marked in FIG. 5B. As a result, as the cam 506a rotates about the cam axle 507, the irregular shape of the pin groove 508 will cause the pin 509, and thus the cam follower 510, to move towards or away from the cam axle 507. As the cam follower 510 moves, it pushes or pulls the pressure wheel carriage 513 with it. When the cam follower 510 is driven to move towards the filament, it will cause the magnets 511a, 511b to move closer together. The magnetic repulsion between the magnets 511a, 511b will push the pressure wheel carriage 513 towards the filament 515. When the pressure wheel 512 comes into contact with the filament 515, part of the force exerted by the cam 506a will be taken up in overcoming the magnetic repulsion between the magnets 511a, 511b. When the cam follower 510 is driven to move away from the filament 515, the cam follower 510 will first move away from the pressure wheel carriage 513 until it reaches the maximum separation extent (during which time the pressure wheel 512 will remain in contact with the filament 515, but while exerting gradually reducing pressure), and then the mechanical engagement between the pressure wheel carriage 513 and the cam follower 510 will cause the pressure wheel carriage 513 to be pulled away out of engagement with the filament 515.

In FIG. 5C, a top view of the assembled filament drive mechanism is shown. This shows three cams mounted on a single shaft/axle 507. A single servo 518 is connected to the cam axle 507. This servo 508 controls the rotational position of the cam axle 507, and thus the rotational position of each of the three cams mounted thereon. Three cam followers are connected to respective ones of the cams, and three pressure wheel carriages are each linked to a respective one of the cam followers. The cams (and more specifically the path of the pin groove) are preferably shaped such that one revolution of the cam bar pushes the relevant cam follower 510 such that its respective filament is engaged against the stepper drive shaft 516b. The position of the cams allows for the differing combinations to be made in one revolution of the cam axle 507. The stepper motor 519 causes rotation of the stepper drive shaft.

The rotational position of the cam axle 507 is controlled (indexed) using a servo or stepper motor. The drive shaft for driving the filament through the drive mechanism is driven by a stepper motor, which could be geared to increase force. The use of cam followers which are coupled to the pressure wheel carriages with magnet springs brings a variety of benefits. In particular, when the force applied by the cam-follower urges the drive wheel to press the filament on to the stepper-drive, the opposing magnets via which the cam follower is connected to the pressure wheel carriage act as a spring to take up differences and apply tension. Slippage of the filament is a common problem, and the magnetic carriages help to provide a consistent force whilst allowing for changes in filament diameter (for example due to the use of a filament with an inconsistent diameter, or to account of different filaments being used and having different diameters). A servo can be used, which accurately maintains its rotational position (thus enabling the cam axle rotational position to be accurately controlled), but equally a stepper motor could be used, but in this case a sensor would be required to know the position and this would be lost with power down.

In FIG. 5E, the drive wheel 516a, and upper and lower nipples 515a, 515b can be seen more clearly. The nipples 515a and 515b assist the filament material in being fed smoothly, and without kinking, through the mechanism. The nipples guide the filament as close to the stepper-drive before and after. This helps prevent buckling of the filament particularly a problem with flexible filaments. The inlet nipple and tapered entry helps smoothly guide the filament from the tube so it easily loads and has no space to buckle. Equally the triple drive mechanism could have 4, 5 6 or more cams so as to feed more than 3 filaments, meaning different colours and materials could be used in many different combinations.

It will be appreciated that alternative cam-based mechanisms could be used. For example, and as shown in FIG. 5F, a cam-based mechanism using the perimeter of a cam 556a in combination with a biasing component 570 and a cam follower 575 are certainly envisaged as viable alternatives. In this embodiment, a wheel carriage 563 comprises the cam follower 575 which causes the wheel carriage 563 to move towards and away from the drive wheel as the cam 556a rotates. The biasing component 570, in this case a folded metal spring, is engaged between the casing of the drive mechanism (at points ‘A’) and shoulders CB′ on the wheel carriage 563, thereby biasing the wheel carriage 563 towards the cam 556a. A pressure wheel 562 is movably mounted to the wheel carriage 563, and biased towards a drive wheel 566a by an extension 570b to the biasing component 570. In FIG. 5G, it can be seen that an axle 580 of the pressure wheel 562 is located within a slot 582, to permit the relative movement between the pressure wheel 562 and the wheel carriage 563. Accordingly, the pressure wheel 562 is able to move (with respect to the wheel carriage 563) over a short distance, to achieve the same effect as the magnetically opposed first and second parts of the previous embodiment. The biasing part 570 can be considered as a metal spring having first and second spring elements. The first spring element biases the wheel carriage towards the cam (and away from the drive wheel), while the second spring element biases the pressure wheel towards the drive wheel. In use, the cam action overcomes the influence of the first spring element, while contact with the filament overcomes the influence of the second spring element, thereby retaining the pressure wheel in close contact with the filament when the filament is to be driven through the mechanism.

In this alternative embodiment, the moulded nipples 515a, 515b are not used. Instead, as can be seen in FIG. 5H, replaceable inserts 515c, 515b are provided. These are separate from the main body of the drive mechanism housing, and may be inserted into openings in the housing, as shown. As a result, the inserts 515c, 515d may be formed of a different material than the main body. It will be appreciated that the inserts may be subject to high levels of wear due to being in a friction relationship with the filament, which may include strengthening fibres. The inserts may therefore be made of a harder material than the body to accommodate wear. The inserts may also be made of a lower friction material to assist with the passage of the filament. Furthermore, as discussed above, it may be desirable to be able to accommodate different filament pitches. This can be readily achieved simply by swapping out an insert having one internal bore diameter for an insert having a different internal bore diameter. Each insert has an open end 590 proximate the drive wheel and pressure wheel, which is chamfered to enable it to extend more closely to the wheels to minimise the length over which the filament is unsupported.

A simplified version of the mechanism could simply use a cam to directly engage filaments, rather than being used to urge a separate spring plate against the filaments.

Filament Elevator

As discussed above, it is desirable to keep the length of the filament path between the filament drive mechanism and the print head relatively constant. A reduced variation in the filament path requires the filaments are stored within the enclosure. Further, filaments may suffer from water absorption, and thus housing them inside would reduce this without needing to contain the filaments within a sealed housing. Moreover, by having the filament and drive mechanism close to the print head rather than at the top or side of the printer the paths are consistent and shorter resulting in less friction. As a result, a consistent force is required to drive the filament to the print head, rather than a force which varies substantially as a function of current distance between filament drive mechanism and print head. Slippage of the filament is a common problem and because FDM requires a high level of accuracy in the filament being driven to the print head, changes in friction within the tubes through which the filament are driven (between the drive mechanism and print head) can change the amount of filament fed to the print head. Further, flexible filaments may suffer from jams when used with long print paths.

As discussed above, a delta printer has a fixed print bed with the print head moving in x, y and z directions. Excess weight on the print head platform adds extra momentum to the print head platform and therefore any excess weight decreases its accuracy (or requires it to be moved more slowly, increasing print times). A filament driven through tubing to the printhead is susceptible to friction, because the longer the tubing the greater the friction, and twists in the filament tubing path also increase friction. Greater friction leads to a higher probability of jams and an inconsistent amount of filament being driven to the print head. With filament reels at a fixed position, which is common among delta printers, the filament tubing path must flex and change its position as the printhead moves. This will alter the friction in the tubing and thus variation in the necessary driving force of the filament drive mechanism.

Ideally, both the filament reel tubing path and the filament drive mechanism would be mounted directly onto the print head platform to avoid friction related problems. However, the excess weight on the printhead platform would decrease the accuracy of printing. The proposed filament elevator addresses this by “floating” above the print head, which keeps the distance between the filament spools and the print head platform more consistent. The filament elevator bears the filament reels on its upper surface, and has the drive mechanism suspended beneath it, which allows for a consistent filament path from the reels to the drive mechanism. From the drive mechanism to the printhead the filament tubes and therefore paths are held within an elasticated plate which minimizes the tube (path) length and the number of twists within the tube length to minimize pathlength. This creates a more consistent pathlength and therefore reduces changes in the in the friction experienced by the filament increases the accuracy of prints. The filament elevator moves up and down by means of the upper most printhead drive carriage. The weight of the filament elevator is taken up by means of a pulley or elastic mechanism suspended from the top of the printer. Due to the need to drive only a small proportion of the overall weight of the filament elevator (most of the weight being supported by the pulley or elastic mechanism), the driving forces within the printhead drive carriages are little changed by the additional weight of the filament elevator.

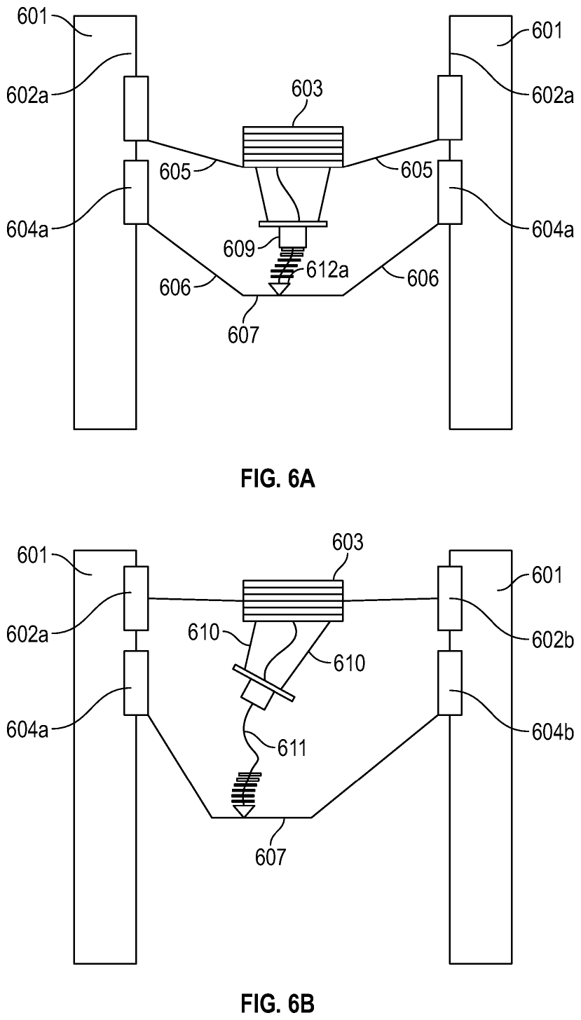

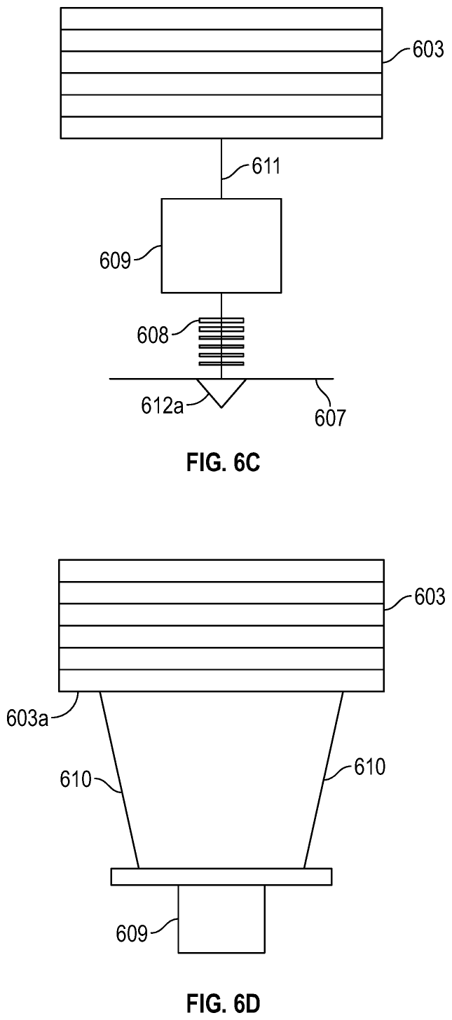

FIGS. 6A to 6D shown the filament elevator within the printing chamber. In particular, FIGS. 6A and 6B show the filament elevator and associated print head platform at two different positions within the printing chamber. FIG. 6C shows the filament elevator and drive mechanism in greater detail. FIG. 6D shows the filament elevator, drive mechanism and print head in greater detail. A printhead platform 607 is linked by connecting rods 606 to moving carriages 604. The rods 606 are able to pivot freely at both ends (that is, at the carriage 604, and at the printhead platform 607). One carriage 604 is provided on each of the 3 pillars. By moving the carriages 604 up and down independently, it is possible for the printhead platform 607 to move about and print material on a print bed. This allows for movement of the printhead in the x, y and z directions, as described above. Generally the carriages 604 are driven up and down their pillars by either a screw drive or belt drive (not shown in the diagrams, and not material to the invention). For simplicity of explanation, the delta printer is represented with 2 pillars. The printhead platform 607 has a printhead 612 mounted on it. Suspended above this and from a filament reel 603, is the filament drive mechanism. The filament reel 603 is suspended from the pillars 601 in a similar fashion to the printhead platform 607. In particular, 3 sets consisting of a connecting rod 605 connected to a carriage 602a which is constrained to move up and down the pillar 601. Filament 611 is drawn from the filament reel 603 by the filament drive mechanism 609 into the printhead 612.

In FIG. 6C, the filament elevator is shown without the connecting rods 605. The filament reel 603 is mounted on a filament reel platform 603d. Suspended below this by 3 flexible connecting rods 610 is the drive mechanism platform 610a. Mounted to the bottom of the drive mechanism platform is the drive mechanism 609.

In FIG. 6D, 3 filament reels 603 a,b and c are shown to be housed within the filament reel platform 603d. One of each of the filaments are fed through holes in the filament reel platform 603d and holes in the drive mechanism platform to the drive mechanism. The triple drive mechanism 609a feeds the 3 filaments to a triple hotend 612a. The filaments 611 a,b and c run through tubes. The tubes act as guides to prevent the filament from kinking as it is pulled and pushed by the drive mechanism 609a.

Comparing FIGS. 6A and 6B, it can be seen that as the printhead platform 607 is moved to the left, the carriage 604a must rise and carriage 604b must fall. Filament carriage 602a is raised by the action of carriage 604a moving up. Since the filament reel connecting rods 605 are rigid, the carriage 602b does not fall with the carriage 604b, but instead moves with the carriage 602a. If the printhead platform were to move to the right, then carriage 604b would rise and lift carriage 602b up with it. As a result, the filament elevator remains at a maximum distance of the length of rod 606 above the printhead platform 607. Since the printhead platform is on the left hand side the drive mechanism platform 610a is pulled and tilts in the direction of the printhead platform. The fact that the rods 610 connecting the filament reel platform 603d to the drive mechanism platform 610a are flexible allows for this movement. As the filament platform 607 is moved around to print items this mechanism allows the drive mechanism to follow the printhead.

It will therefore be appreciated that the filament elevator keeps the drive mechanism and filament paths more consistent and shorter, and permits filaments to be stored in the sealed enclosure of the printing chamber, thus keeping the filaments dry. The filaments can easily be changed because the three spools are separable. When an upper spool of the set of spools is released from a lower spool, it is lifted upwards on the counterbalance mechanism, enabling easy removal from the 3D printer. Once removed from the printer, the spool can then be separated from the counterbalance mechanism, and replaced. In other words, the top spool is releasably attached to the counterbalance mechanism, the middle spool is releasably attached to the top spool, the bottom spool is releasably attached to the middle spool, and the elevator platform may be releasably attached to the bottom spool.

In a variation of the above, the elevator could take the form of a disc, mounted between the upper (filament) carriages, with the spools mounted (suspended) beneath it. If provided, the counterbalance may then be connected to the disc shaped elevator platform.

Magnetic Tensioners

As discussed above, the print head platform is moved using three independent carriages which move vertically on respective vertical pillars. This is the standard setup for a delta printer. Conventional carriages suffer from certain disadvantages, and to address these disadvantages the present 3D printer may utilise magnetic spring wheel carriage tensioners. Linear rails are commonly used for achieving linear motion in various machines, not just for 3D delta printers. Carriages run on these rails, and driving the carriage can move items in a machine (such as, but not limited to, a delta printer). One common rail system is a v-slot, in which some carriages are retained against the linear rail by gravity while other use opposing wheels running either side of (at least a portion of) the rail(s). These commonly have 4 wheels, 2 either side but some may have many more.

CNC routers, laser cutters and other similar machines typically utilize extruded aluminium profile with a “V slot” for form the vertical pillars. Carriages that run on this type of extruded profile comprise wheels having chamfered edges. When pairs of these wheels are used on opposite sides of the profile a method of adjusting the distance between the pair of wheels, and thus the clamping pressure on the pillar, and thus the friction which prevents slippage is required. Tension of the wheels against either side of the rail is controlled by providing the wheels on one side on a cammed screw, which can be used to adjust tension so that the carriage is closely retained against the rail but also runs freely. This requires regular maintenance to ensure the tension remains at the correct level. If the wheels are too loose the carriage will wobble, while if the wheels are too tight then slight changes in the profile/thickness of the rail would lock up the carriage and inhibit motion. If twin rails are used with a common carriage travelling between them, the dimension between the pair of rails may change along the length of the twin rails. This would conventionally require the cam-screws to be adjusted to be looser to prevent the wheels jamming, but at the loss of accuracy (increased wobble). By use of magnets the need for adjustment is eliminated, as changes in dimension along the single or double rails are automatically taken up, preventing wobble at all points.

The 3D printer described herein uses opposed magnets to address the disadvantages of the prior art. The opposed magnets act within the carriage to urge the wheels against the profile of the pillar. This reduces the need for periodic/continual adjustments which would otherwise be necessary to maintain the correct friction between the carriage wheels and the profile, thereby allowing the carriages to move freely along the profile/linear rails. The present technique is advantageous over the used of springs for the same purpose. In particular, the force applied by a conventional spring would generally decrease over time, while a cam would become looser as the wheel wears. In contrast, by directly replacing the spring with magnets, these problems are alleviated—provided that the magnetic attraction/repulsion between the opposed magnets does not diminish over time. With a cam as the dimension of the machine change along the length of two parallel rails the friction increases and decreases, with a spring or magnet spring this is taken up by the change in position allows for by the spring/magnet but not by the cam. This is particularly emphasized when using rails in the vertical direction.

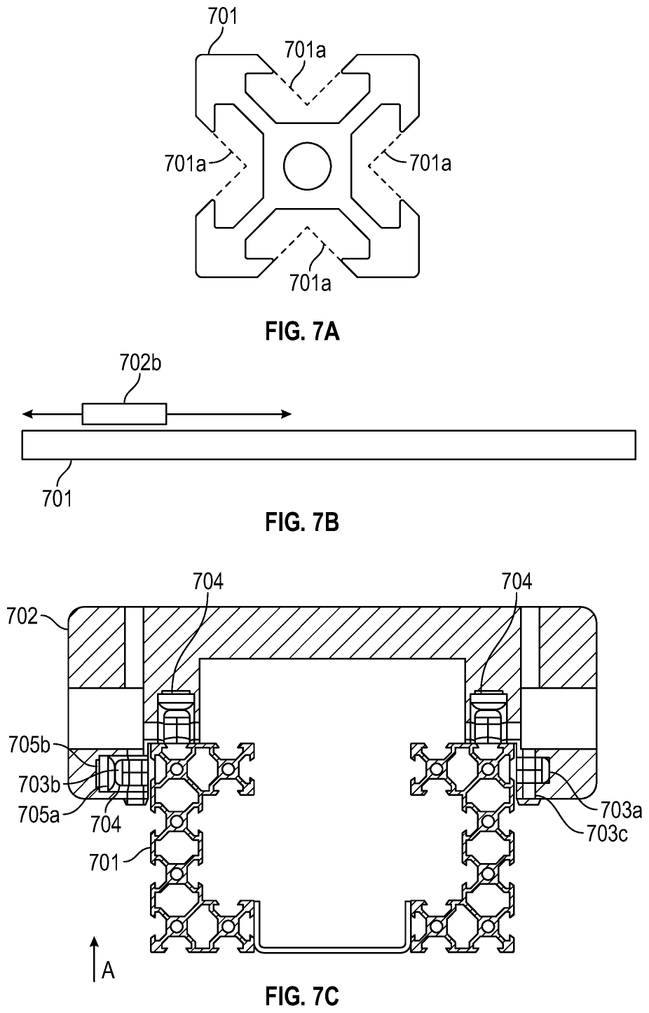

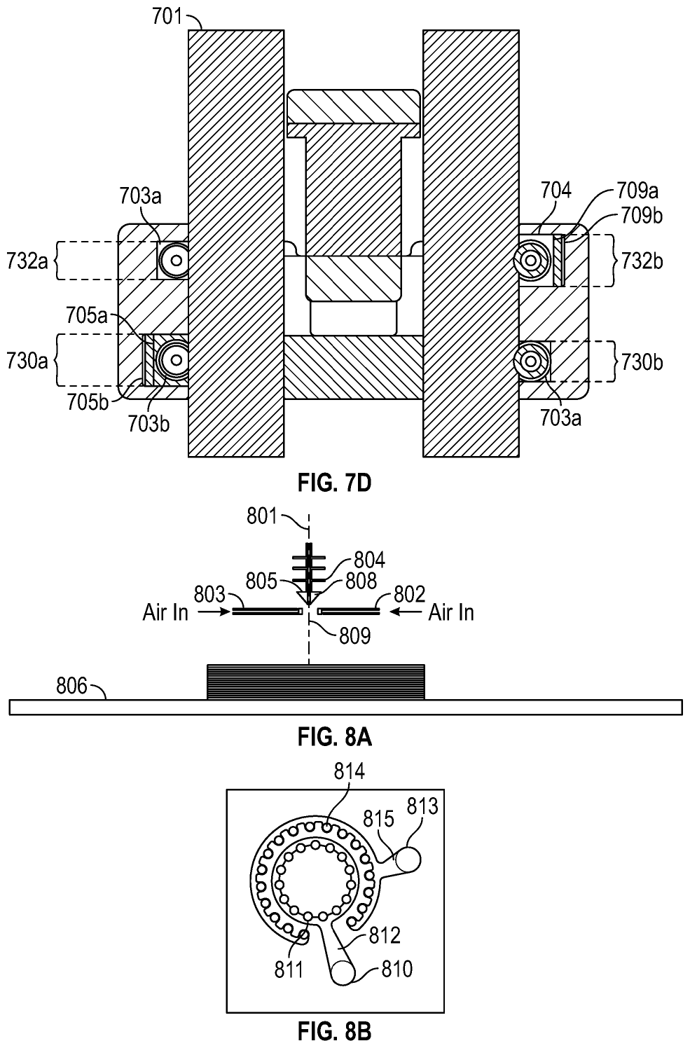

FIGS. 7A to 7C show the proposed mechanism for engaging a carriage with a linear rail. FIG. 7A shows a cross section of a part of a linear rail in the form of a V slot extrusion 701. FIG. 7B shows a carriage positioned with respect to a linear rail. FIG. 7C shows the engagement between a cross section of linear rail and a carriage, while FIG. 7D shows the arrangement of FIG. 7C viewed from below. The proposed mechanism could equally be another type of linear rail. Referring to FIG. 7A, the extrusion 701 is generally square in cross section, but has a groove or channel 701a extending along each face. The wheels of a carriage intended to travel along the linear rail are required to engage with one or more of the channels 701a, and thus have shaped edges in order to achieve this. Referring to FIG. 7B, a carriage 702b is shown positioned on and movable along the linear rail 701. In the case of a horizontal rail (as shown), a carriage may simply rest on the rail. However, in the case of a vertical rail, a carriage would be required to engage with two opposing sides of the rail in order to be retained against the rail, such as in the manner of FIG. 1E, as described above.

Referring to FIG. 7C, a carriage 702 is mounted to the linear rail via four sets of wheels. A first two sets of opposing wheels respectively engage with opposing faces of the linear rail 701, while a second two sets of wheels engage with the same face of the linear rail 701. The carriage 702 is “U” shaped, having a first part which extends between the second and third parts. The first two sets of wheels are disposed on the inside of the second and third parts (the legs of the “U”), and the second two sets of wheels are disposed on the inside of the first part of the “U”. As a result, the carriage extends around, and engages with, 3 faces of the linear rail 701.

The carriage 702 comprises a plurality of wheel carriages 704, each of which bear one of the wheels 703b. In particular, each of the wheel carriages 704 has a pivot, on which the respective wheel 703b is mounted. Not all of the wheels are mounted on wheel carriages (in this embodiment, although in other embodiments they may be). In particular, the wheels 703a rotate about pivots 703c provided in the carriage 702 itself. The wheel carriages sit in a wheel carriage slot inside of the carriage 702. A first magnet 705a is fixed to the wheel carriage 704. A second magnet 705b is fixed to the rear of the carriage slot. The first and second magnets 705a and 705b are orientated such to repel one another. The repulsion force of the magnets forces wheels carriages 704 and accordingly the wheels 703b against the v-slot extrusion 701. This creates the necessary force to correctly position the wheels against the v-slot extrusion 701. Equally the wheels could be replaced by ball bearings and the extrusion replaced by a rail with a location slot for the ball bearings.

FIG. 4D shows the carriage 702 viewed in the direction ‘A’ in FIG. 4C. Here, it can be seen that a pair of opposed wheels 730a, 730b comprise a first wheel, on one side of the rail 701, which is mounted directly to the carriage, and another wheel, on the opposite side of the rail 701, which is mounted to the carriage 702 via a magnetic wheel carriage. The same applies for the pair of opposed wheels 732a, 732b.

Vented Print Head

During FDM printing plastic filament is driven by a drive mechanism to the print head and then melted through the hot end nozzle, as described above. Current printers use two fans per hot end—one fan to cool the printed material and another fan to cool the filament path that leads to the hot end. Cooling the filament path is important so that the plastic filament remains unmelted prior to it entering the hot end, as it needs to be solid so that it can be pushed into the hot-end. If the filament has melted, or has softened, this will not be possible. Cooling the printed material may be necessary to aid adhesion to the print bed and solidify the printed material. It has been found that by using channels in the print head platform, it is possible to direct air to both of these points. This also reduces the weight on the print bed due to the absence of fans. Further, the printhead may be able to print closer to some edges due to the absence of a fan preventing movement in that direction. Accordingly, the use of a vented print head removes the need for 2 fans, thereby reducing the weight on the print bed, and enabling the print head to reach closer to the edge of the print bed (where a fan would normally be provided).

In particular, the proposed vented print head utilizes an air compressor to pump air through ducts within the print head platform and through holes pointing toward the hot end and the print bed. The holes pointing towards the hot end enable controlled cooling of the filament path to the hot end. For accuracy placement and bonding or print material cooling fan are used by current invention to accurately control the plastic cooling. The vented print bed has holes aimed at the print bed enable controlled cooling of printed material.

Referring to FIG. 8A, a filament 801 enters a hot-end guide 804 and is melted in a nozzle 805 by a heating element 808. A melted filament 809 is extruded from the nozzle 808 onto a print bed 806 as per the FDM process describe above. Air is directed through a print head duct 803 towards the filament hot-end guide 804. This air is directed over cooling fins of the guide 804, to cool it. Air is also directed through a print head duct 802 towards the print bed 806 to cool the extruded filament 807. Referring to FIG. 8B (which shows the underside of the vented print head), a single air inlet 810 may feed multiple outlets 811 through multiple ducts 812. Similarly, for the material cooling ducts 802, a single inlet 813 may feed multiple outlets 814 through multiple ducts 815.

### Working Example

The 3D printer 1 utilizes a sealed chamber to enable a vacuum to be established. By virtue of the combination of the features described above, mouldings can be printed using FDM and then filled with liquid resin (UV, solvent or 2 pack (2 part adhesive, comprising a hardener and resin which are mixed to chemically react and solidify)) and this can be vacuum de-gassed/infused to aid the moulding. Using an existing FDM process a 3D object can be printed, and this object can be designed to form a mould. The mould could for instance be for a watch. The printing process would entail a pause during printing to allow for a pre-manufactured watch mechanism to be placed into the mould. Printing would continue after this pause to complete the mould, with an allowance for the watch glass and for inlet and outlet ports to the mould. Utilizing one of the twin molyneux vacuum pump outlets it is possible to engage the mould whilst simultaneously using the second outlet of the pump (vacuum inlet) to engage the second port on the mould. The vacuum pump would be started and fluid injected through the pump from the first hopper aided by the fact that the hopper is pressurised. This would begin filling the mould. The TMVP second pump, now being utilised as an inlet, sucks the fluid through the mould.

After the fluid has completely filled the mould, the watch face may be printed using the TMVP other hopper a clear fluid would be used and surface tension utilised to obtain a concave surface (if desired, or alternatively convex or flat). The vacuum in the vented hot bed operates through these process to ensure bubbles are removed. If the fluid is either 2 pack solvent or UV curing, the fluid would be left to cure in the necessary manner. For instance, in the case of the product outlined here the FDM printed mould would be of a clear plastic and fluid would be a UV cure resin. This would enable the UV lights to be turned on after the mould has been filled to cure the fluid inside the mould. Other materials such as 2 pack or solvent cure or air cure or any either curing process could be injected without the necessity for the clear mould.

Equally an opaque mould could be used provided that UV light is transmitted through the material. Due to the fact the printer utilizes a triple filament hotend a combination of necessary materials can be printed using the FDM process to enable the printing of a mould made of dissolvable material, parts for the end product to be printed in a variety of plastics and conductive plastics to be printed in the form of electronic circuits. This combination along with the ability to print liquids by the TMVP which can be cured to soft elastomers enables the printing of electronics encased within sealed designs. If the mould is utilised for this and is of a dissolvable material the mould can be dissolved away to leave the end product. Equally, a non-dissolvable material could be used and the mould broken or machined a way. A pause during this process allows for electronic components to be placed within the circuit board printed using the FDM process. These components could be complete and populated circuit boards or individual components (resistors, diodes relays etc.). Motors, or watch mechanisms or similar parts could be placed as the design dictates.

3D Labels may be printed using the FDM process. A flat badge could be printed with a raised perimeter and raised letters or artwork printed within this perimeter using one, two or three different colours or materials. The TMVP can then be used to fill inside this perimeter with a resin having sufficiently viscous fluid allowing it to flow in between and around the artwork or letters. The vented hotbed could be engaged in vacuum mode to aid degassing of the liquid filled FDM printed part, thereby improving the clarity of a clear material by removing air bubbles. For a UV cured clear material, the UV lights of the 3D printer may be turned on thereby curing the resin within and around the FDM printed material.

In some cases, forming a vacuum within the printing chamber and/or the mould may not be necessary because the fluid driven through the pressurised hopper and drawn into the pump may naturally reduce the prevalence of air bubbles within the fluid. The more viscous the fluid, the more likely that bubbles would not be fully expelled from the fluid in the hopper and as such the use of a vacuum may be more beneficial with thicker fluids, for example RTV silicon. This, when placed into the hopper, is more likely to contain air bubbles, which may remain trapped within the fluid when the fluid is deposited from the TMVP. In an example in which two different materials are to be deposited by the TMVP (a double mould), the second pump which has been used to vacuum resin through a mould may create bubbles within the hopper of the second pump. The second pump would generally not use a different material without contamination if a single mould with both an inlet and outlet was made since the fluid dispensed from the first hopper may be drawn into the second hopper. In practice, the use of two different materials may be practical only if the inlet of the mould would be engaged and the outlet left open to the enclosure, thereby allowing for the second pump to suck air from the enclosure (rather than the mould) and therefore not contaminate the different fluid in the second hopper. At the same time, to aid fluid entering the mould and fully filling the mould, the vented hotbed would be engaged in vacuum mode.

The vented hotbed would enable open top moulds to be degassed. Using one half the TMVP enables fluids to be printed in exact amounts. Using UV cure materials and a UV light mounted in the print head platform (or elsewhere within the printing chamber) means these can be printed and cured in a manner similar to FDM. The UV cure fluid can be printed within a channel with the necessary surface tension to create a concave, flat or convex surface, before being cured. With the use of flexible material, this can act as a sealing surface. Open picture frames created using the FDM print head can be filled with liquid. UV curing can be achieved using a series of UV lights mounted through the printer. This enables the fluid to level before being cured. Certain liquids, such as 2 pack or solvent cure resins would cure naturally (without the need for UV light). Operating the vented hotbed in vacuum mode would aid gasses being drawn from the material.

When printing liquid into a mould, the two liquid print heads can be used to engage the mould, such that one of the print heads injects fluid and the other print head vacuums it through the mould, similar to vacuum casting or infusion. The use of laser, cutter and inkpen would allow for engraving art work and vinyl cutting of stickers. The laser can be used to smooth the surfaces and aid bonding of layers by melting between the paths creating a stronger surface. The cutter could cut vinyl placed on the print bed. Tilting of the print bed would enable letters or art to be printed on the tilted surfaces. By combining all of the above processes complete kits of products could be printed. For instance, a supplied kit of parts may be used during the printing process to create electronic or mechanical moving or operating items. These can be combined with stickers or labels cut using the vinyl cutter and or laser/inkpen. The printer process, either created by the user or supplied as part of the kit would be uploaded (to software running on a computer connected to the printer), with pauses in the printing process being define for placement of kit parts, changes of materials, by the user. The kits would then be complete or would require further manual assembly by the user.

Items can be placed on the print bed to be printed onto. For example, a phone may be placed and artwork drawn or lasered thereon, or FDM printed letters added. In order to achieve this, first a print outline is printed then the item placed and printed on. In another example, a dice could be manufactured by first printing a cube, which is then taken from the print bed. A perimeter matching the size of the dice is then printed onto the print bed, and the dice is placed back on the printer (within the perimeter) to print the numbers or dots, then rotated repeatedly for the other 5 sides. This enables consistent printing onto each side of the dice.

1. A 3D printer, comprising:
a housing providing a printing chamber; and
a print head, movably mounted within the housing, for dispensing a printing material; and
a utility head, movably mounted within the housing, bearing one or more of a laser, ink pen or inkjet print head, for adding surface decoration onto the dispensed printing material.

2. A 3D printer according to claim 1, wherein the print head and utility head are both mounted onto a common platform.

3. A 3D printer, comprising:
a housing providing a printing chamber;
a print bed at the base of the printing chamber, the print bed comprising one or more apertures;
a pump device, for drawing air through the apertures, to generate a vacuum beneath an object located on the print bed to retain it in position; and
a utility head, movably mounted within the housing, bearing a cutting tool for cutting the object on the print bed while it is retained in place by the vacuum generated beneath it.

4. A 3D printer, comprising:
a housing providing a printing chamber;
a print bed at the base of the printing chamber, the print bed being tiltable; and
a print head, movably mounted within the housing, for dispensing a printing material while the print bed is horizontal or tilted with respect to the horizontal.

5. A 3D printer according to claim 4, comprising a plurality of pillars, each pillar having a bed carriage arranged to move vertically on the pillar;
wherein the print bed is movably mounted within the housing via the bed carriages of the plurality of pillars, and is tiltable by moving the bed carriages independently of each other.

6. A 3D printer, comprising:
a housing providing a printing chamber; and
a liquid print head, movably mounted within the housing, for dispensing a liquid; and
a print bed at the base of the printing chamber for receiving an object to be fully or partially filled by the liquid print head; and
one or more apertures for drawing air from the object using a vacuum pump.

7. A 3D printer according to claim 6, wherein the apertures are disposed in one or both of the housing and the print head.

8. A 3D printer according to claim 6, wherein the one or more apertures are disposed in the print bed.

9. A 3D printer according to any one of claims 6 to 8, wherein the printing chamber is a sealed chamber, and the vacuum pump is operable to draw air out of the printing chamber via the one or more apertures.

10. A 3D printer according to any one of claims 6 to 9, further comprising a further print head for printing the object onto the print bed prior to it being filled using the liquid print head.

11. A 3D printer according to claim 10, wherein the further print head is a fused deposition modelling (FDM) print head.

12. A 3D printer according to claim 10 or claim 11, wherein the liquid print head is operable to dispense liquid into a first opening into the object while the one or more apertures draw air from the interior of the object via a second opening into the object.

13. A 3D printer according to claim 12, wherein the further print head is operable to complete the mould by printing over the first and/or second opening once a process of dispensing liquid into the mould has been completed.

14. A 3D printer according to any one of claims 6 to 13, comprising a hopper containing the liquid, and wherein the hopper is pressurised by the pumping action of the vacuum pump.

15. A 3D printer according to any one of claims 6 to 14, comprising the vacuum pump.

16. A 3D printer according to claim 10, wherein the further print head is operable to pause printing, and the housing may be opened to permit the manual insertion of an external object into the mould.

17. A 3D printer according to claim 16, wherein the manual insertion of the external object occurs prior to, or part-way through, liquid being dispensed into the mould.

18. A 3D printer according to claim 10, comprising a filament drive mechanism supplying filaments of printing material to the further print head, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

19. A filament drive mechanism for a 3D printer, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

20. A filament drive mechanism according to claim 19, wherein the plurality of drive surfaces are arranged on a single drive shaft.

21. A filament drive mechanism according to claim 19 or claim 20, wherein the plurality of cams are arranged on a single cam shaft, and wherein the rotational position of the cam shaft controls the rotational position of the cams.

22. A filament drive mechanism according to any one of claims 19 to 21, wherein the plurality of pressure surfaces form part of respective cam following units, each cam following unit being movable within a channel under the action of the respective cam to engage and disengage the pressure surface from the filament.

23. A filament drive mechanism according to claim 22, wherein the plurality of pressure surfaces are wheels mounted within the cam following units.

24. A filament drive mechanism according to claim 22 or claim 23, wherein each cam following unit comprises first and second parts, the first part being coupled to the cam and the second part bearing the pressure surface, the first and second parts being biased away from each other via one or more biasing elements, wherein when the pressure surface is pressed against the filament the force applied from the cam to the pressure surface via the biasing elements overcomes the bias to move the first and second parts closer to each other.

25. A filament drive mechanism according to claim 24, wherein the biasing elements each comprise a pair of opposed magnets, the action of the cams overcoming a magnetic repulsion between the pair of magnets.

26. A filament drive mechanism according to any one of claims 19 to 25, comprising at least 3 filaments, at least 3 drive surfaces, at least 3 pressure surfaces and at least 3 cams.

27. A filament drive mechanism according to any one of claims 22 to 26, wherein the cam following unit is coupled to its respective cam by a pin which engages with a groove on the cam, the groove defining a path on the cam which causes the pin, and therefore the cam following unit, to move towards or away from the filament as the cam is rotated and the pin follows the path of the groove.

28. A filament drive mechanism according to claim 27, wherein the groove is similar in shape to, and proximate, a circumference of the cam.

29. A filament drive mechanism according to any one of claims 19 to 28, wherein the cam following unit comprises a cut-out portion or slot which the rotational axis of the cam extends through.

30. A filament drive mechanism according to any one of claims 19 to 29, wherein the drive surfaces each comprise a drive wheel coupled to a motor.

31. A filament drive mechanism according to claim 30, wherein the drive wheel is toothed.

32. A filament drive mechanism according to claim 30 or claim 31, wherein the filament path enters the filament drive mechanism at an inlet and exits the filament drive mechanism at an outlet, the filament path being surrounded by a first guide formation proximate the inlet and a second guide formation proximate the outlet and being exposed between the first and second guide formations in the vicinity of the respective drive surface.

33. A filament drive mechanism according to claim 32, wherein the first guide formation and the second guide formation taper towards the position of the drive surface to permit the filament to be in contact with the drive surface over a short length.

34. A filament drive mechanism according to any one of claims 19 to 33, wherein the rotational position of the cams is controlled by a servo or stepper motor.

35. A filament drive mechanism according to any one of claims 19 to 34, wherein the shape of the cams and/or the paths of the grooves on the cams and/or the rotational positions of the cams on the cam shaft relative to each other are such that by varying the rotational position of the cam shaft a selected two or more of the pressure surfaces can be brought into contact with the respective filaments at the same time.

36. A filament drive mechanism according to claim 35, wherein the shape of the cams and/or the paths of the grooves on the cams and/or the rotational positions on the cams on the cam shaft relative to each other are such that at one or more rotational positions of the cam shaft all of the pressure surfaces can be brought into contact with the respective filaments at the same time.

37. A filament drive mechanism according to claim 35 or claim 36, wherein a first of the two or more pressure surfaces in contact with the filaments applies sufficient pressure to fully engage the filament with the drive surface while a second of the two or more pressure surfaces in contact with the filaments applies sufficient pressure to only partially engage the filament with the drive surface.

38. A filament drive mechanism according to claim 35 or claim 36, wherein any individual pressure surface or combination of pressure surfaces can be brought into contact with the respective filaments at the same time by setting an appropriate rotational position of the cam shaft.

39. A filament drive mechanism according to claim 38, wherein an amount of engagement of a filament with the respective drive surface can be controlled by setting an appropriate rotational position of the cam shaft.

40. A 3D printer, comprising:
a housing providing a printing chamber; and
a print head, movably mounted within the housing, for dispensing a printing material; and
a filament drive mechanism according to any one of claims 14 to 34, the filament drive mechanism being operable to supply a selected filament to the print head.

41. A 3D printer, comprising:
a housing providing a printing chamber;
a print bed at the base of the printing chamber; and
a pump device;
wherein the print bed comprises a heating element, and one or more conduits disposed proximate the heating element, and wherein the pump is operable to drive or draw air through the conduits and into the printing chamber.

42. A 3D printer according to claim 41, wherein the heating element is substantially planar and extends across the print bed.

43. A 3D printer according to claim 42, wherein the one or more conduits extend from an inlet to an outlet at or near the periphery of the print bed.

44. A 3D printer according to claim 43, wherein the inlet is disposed beneath the heating element.

45. A 3D printer according to claim 43 or claim 44, wherein the inlet is disposed substantially centrally of the heating element, and wherein a plurality of conduits are provided which extend from the inlet to a plurality of outlets about the periphery of the print bed.

46. A 3D printer according to claim 45, wherein the plurality of conduits extend radially from the inlet to their respective outlets.

47. A 3D printer according to any one of claims 41 to 46, wherein the one or more conduits extend horizontally beneath the heating element.

48. A 3D printer according to any one of claims 41 to 47, wherein the pump device is operable in a vacuum mode to draw air from the printing chamber and through the one or more conduits to evacuate the printing chamber.

49. A 3D printer according to claim 48, comprising an exhaust through which the evacuated air is expelled to the atmosphere.

50. A 3D printer according to claim 48 or claim 49, comprising a filter for filtering the evacuated air.

51. A 3D printer according to any one of claims 41 to 50, comprising a temperature sensor for measuring a temperature within the printing chamber, and a controller for controlling the operation of the pump device in dependence on the measured temperature to achieve and/or maintain a desired temperature within the printing chamber.

52. A 3D printer according to claim 51, wherein the pump device comprises a valve and a pumping motor, and wherein the controller is operable to control one or both of the valve and the motor to regulate an air flow rate through the one or more conduits.

53. A 3D printer according to any one of claims 41 to 52, wherein the pump device comprises an air pump for driving air through the one or more conduits and into the printing chamber, and a vacuum pump for drawing air out of the printing chamber and through the one or more conduits, and a valve for selecting which one of the air pump and the vacuum pump is in fluid communication with the one or more conduits.

54. A 3D printer according to any one of claims 41 to 53, wherein the pump device is located beneath the printing bed.

55. A 3D printer according to any one of claims 41 to 54, comprising a print head, movably mounted within the printing chamber, for dispensing a printing material onto the printing bed.

56. A 3D printer according to claim 55, wherein the print head is operable to print over and seal one or more of the apertures to control the flow of air into and/or out of the printing chamber.

57. A 3D printer according to any one of claims 41 to 56, comprising a liquid print head, movably mounted within the housing, for dispensing a liquid; wherein the print bed is for receiving an object to be fully or partially filled by the liquid print head; and the 3D printer comprises one or more apertures for drawing air from the object using a vacuum pump.

58. A 3D printer according to claim 55, comprising a filament drive mechanism for supplying filaments of printing material to the print head, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

59. A 3D printer, comprising:
a housing providing a printing chamber;
a print head platform, movably mounted within the housing, having a print head for dispensing a printing material, the print head platform being movable vertically and horizontally; and
a filament elevator, movably mounted within the housing, for carrying one or more filaments of printing material for use by the print head, the filament elevator being movable vertically to stay within a first predetermined distance from the print head platform.

60. A 3D printer according to claim 59, wherein the filament elevator is movable vertically to stay outside of a further predetermined distance from the print head platform.

61. A 3D printer according to claim 59 or claim 60, comprising a plurality of pillars, each pillar having first and second carriages arranged to move vertically on the pillar, the second carriage being disposed above the first carriage;
wherein the print head platform is movably mounted within the housing via the first carriages of the plurality of pillars, and is movable vertically and horizontally by moving the first carriages independently of each other;
wherein the filament elevator is movably mounted within the housing via the second carriages, the filament elevator being movable vertically by moving the second carriages together; and
wherein the second carriages are constrained to move together vertically on the pillars, and wherein the vertical position of the second carriages is dictated by the vertical position of the highest one or more of the first carriages.

62. A 3D printer according to claim 61, comprising a drive mechanism for controlling the vertical position of each of the first carriages independently, wherein if the drive mechanism causes the highest one or more of the first carriages to move upwardly, the second carriages are carried upwardly with the highest one or more of the first carriages, and wherein if the drive mechanism causes the highest one or more of the first carriages to move downwardly, the second carriages are permitted to move downwardly.

63. A 3D printer according to any one of claims 59 to 62, wherein the filament elevator carries a filament drive mechanism for extruding the filaments towards the printing head.

64. A 3D printer according to claim 63, wherein the extruded filament is conveyed to the printing head via a tube.

65. A 3D printer according to claim 61, wherein the first carriages are coupled to the printing head platform by connecting rods, each connecting rod being pivotally mounted both to the printing head platform and to its first carriage, and wherein the second carriages are coupled to the filament elevator by fixed connecting rods.

66. A 3D printer according to claim 61, wherein the filament elevator is connected to an upper part of the housing by a support mechanism, the support mechanism bearing a substantial portion of the weight of the filament elevator, the remainder of the weight of the filament elevator being sufficient to drive the second carriages downwardly to follow the highest one or more of the first carriages when the highest one or more of the first carriages is caused to descend.

67. A 3D printer according to claim 66, wherein the support mechanism comprises one of a pulley or an elasticated support.

68. A 3D printer according to any one of claims 59 to 67, wherein the print head platform has a liquid print head, for dispensing a liquid; wherein a print bed is disposed at or near the base of the printing chamber for receiving an object to be fully or partially filled by the liquid print head; and the 3D printer comprises one or more apertures for drawing air from the object using a vacuum pump.

69. A 3D printer according to claim 63 or claim 64, the drive mechanism comprising:
one or more drive surfaces for driving respective filaments along one or more respective filament paths while the filaments are pressed against respective drive surfaces, each drive surface being unable to drive its respective filament along its filament path if the filament is not pressed against the drive surface;
a plurality of pressure surfaces, each being associated with one of the drive surfaces, each pressure surface being arranged to press against a respective filament to enable it to be driven by the driving surface; and
a plurality of cams, each cam being associated with one of the pressure surfaces, wherein the rotational position of the cams controls which of the plurality of pressure surfaces are pressed against their respective filaments.

70. A 3D printer according to any one of claims 59 to 69, comprising a print bed at the base of the printing chamber, and a pump device; wherein the print bed comprises a heating element, and one or more conduits disposed proximate the heating element, and wherein the pump is operable to drive or draw air through the conduits and into the printing chamber.
